(19) United States
(12) Patent Application Publication
(10) Pub. No.: US 2026/0087931 A1
(43) Pub. Date: Mar. 26, 2026

(54) SYSTEMS AND METHODS FOR COOPERATIVE NAVIGATION WITH AUTONOMOUS VEHICLES

(71) Applicant: Ohio State Innovation Foundation, Columbus, OH (US)

(72) Inventors: Rahan KHAN, Columbus, OH (US); Athar HANIF, Columbus, OH (US); Qadeer AHMED, Plain City, OH (US)

(21) Appl. No.: 19/106,073

(22) PCT Filed: Aug. 28, 2023
(86) PCT No.: PCT/US2023/031230

§ 371 Date: Feb. 24, 2025

Related U.S. Application Data
(60) Provisional application No. 63/373,618, filed on Aug. 26, 2022.
(60) Provisional application No. 63/456,930, filed on Apr. 4, 2023.

(51) Int. Cl. G08G 1/0967; G08G 1/01; G08G 1/16

(52) U.S. Cl. CPC G08G 1/096725; G08G 1/0116; G08G 1/0141; G08G 1/0145; G08G 1/096783; G08G 1/164; G08G 1/166

(57) ABSTRACT

An example for performing cooperative navigation with autonomous vehicles includes an autonomous vehicle; a communication system; and a vehicle control system operably coupled to the autonomous vehicle, the vehicle control system including a processor and a memory, the memory having computer-executable instructions stored thereon that, when executed by the processor, cause the processor to: receive traffic information from the communication system, where the traffic information includes information from a plurality of roadside communication devices and information from a second vehicle; receive a plurality of vehicle parameters associated with the autonomous vehicle; and determine, based on the traffic information and the vehicle parameters, a cooperative navigation solution.

### CROSS-REFERENCE TO RELATED APPLICATIONS

This application claims the benefit of U.S. provisional patent application No. 63/456,930, filed on Apr. 4, 2023, and titled “SYSTEMS AND METHODS FOR ANALYZING SMART INTERSECTIONS WITH HIGHLY AUTOMATED VEHICLES,” and U.S. provisional patent application No. 63/373,618, filed on Aug. 26, 2022, and titled “SYSTEMS AND METHODS FOR OPERATING SMART INTERSECTIONS WITH AUTONOMOUS VEHICLES,” the disclosures of which are expressly incorporated herein by reference in its entirety.

### STATEMENT REGARDING FEDERALLY FUNDED RESEARCH

This invention was made with government support under grant/contract number 69A3552047138 awarded by the U.S. Department of Transportation. The government has certain rights in the invention.

### BACKGROUND

Autonomous vehicles can navigate between two points without a human driver, or with limited human input. Autonomous vehicles can include sensors, computer systems, and communication systems, which can be used to identify obstacles, perform and collision avoidance while the autonomous vehicle is navigating along a route. Autonomous vehicles can also include route planning systems.

Highly automated vehicles can identify obstacles, and perform collision avoidance while the autonomous vehicle is navigating along a route. Highly automated vehicles can also perform route planning and navigation between waypoints.

Both autonomous vehicles and highly automated vehicles can operate in conjunction with smart infrastructure systems. Smart infrastructure systems can be used to monitor and/or control roadways, for example by controlling traffic signals.

Therefore, what is needed are systems and methods for using autonomous vehicles and/or highly automated vehicles with smart infrastructure. For example, systems and methods for avoiding collisions between vehicles. For example, systems and methods for avoiding collisions between vehicles.

### SUMMARY

Systems for performing cooperative navigation with autonomous vehicles and/or highly automated vehicles, are described herein.

In some aspects, the techniques described herein relate to a system for performing cooperative navigation with autonomous vehicles, the system including: an autonomous vehicle; a communication system; and a vehicle control system, the vehicle control system including a processor and a memory, the memory having computer-executable instructions stored thereon that, when executed by the processor, cause the processor to: receive traffic information from the communication system, wherein the traffic information includes first information from a plurality of roadside communication devices and second information from a second vehicle; receive a plurality of vehicle parameters associated with the autonomous vehicle; determine, based on the traffic information and the vehicle parameters, a cooperative navigation solution.

In some aspects, the techniques described herein relate to a system, further including controlling the autonomous vehicle using the cooperative navigation solution.

In some aspects, the techniques described herein relate to a system or claim 2, wherein the vehicle control system is attached to the autonomous vehicle.

In some aspects, the techniques described herein relate to a system, wherein the cooperative navigation solution includes a vehicle velocity instruction, wherein the vehicle velocity instruction includes a velocity that avoids a potential collision.

In some aspects, the techniques described herein relate to a system, wherein the cooperative navigation solution includes a cooperative cruise control instruction.

In some aspects, the techniques described herein relate to a system, wherein the cooperative navigation solution includes cooperative adaptive lane keeping information.

In some aspects, the techniques described herein relate to a system, wherein the cooperative navigation solution includes cooperative collision avoidance information.

In some aspects, the techniques described herein relate to a system, wherein the roadside communication devices include a road side unit (RSU).

In some aspects, the techniques described herein relate to a system, wherein the roadside communication devices include a smart traffic light (STL).

In some aspects, the techniques described herein relate to a system, wherein the roadside communication devices include a smart traffic sign (STS).

In some aspects, the techniques described herein relate to a system, wherein the roadside communication devices include an automated traffic management (ATM) system.

In some aspects, the techniques described herein relate to a system, wherein the vehicle parameters include a vehicle length.

In some aspects, the techniques described herein relate to a system, wherein the vehicle parameters include a vehicle position.

In some aspects, the techniques described herein relate to a system, wherein the vehicle parameters include a heading angle.

In some aspects, the techniques described herein relate to a system, wherein the vehicle parameters include a lane identity of the vehicle.

In some aspects, the techniques described herein relate to a system, wherein the vehicle parameters include a turn identification of the vehicle.

In some aspects, the techniques described herein relate to a system, wherein the communication system includes an autonomous intersection management system.

In some aspects, the techniques described herein relate to a system, further including a light detection and ranging (LIDAR) sensor, and wherein the plurality of vehicle parameters include LIDAR data.

In some aspects, the techniques described herein relate to a system, further including a radar sensor, and wherein the plurality of vehicle parameters include radar data.

In some aspects, the techniques described herein relate to a system, further including a camera, and wherein the plurality of vehicle parameters include image data.

In some aspects, the techniques described herein relate to a computer-implemented method of performing cooperative collision avoidance for an autonomous vehicle, the method including: receiving traffic information from a communication system, wherein the traffic information includes information from a plurality of roadside communication devices and information from a second vehicle; receiving a plurality of vehicle parameters associated with the autonomous vehicle; determining, based on the traffic information and the vehicle parameters, a cooperative navigation solution.

In some aspects, the techniques described herein relate to a computer-implemented method, wherein the cooperative navigation solution includes a vehicle velocity, wherein the vehicle velocity is a velocity that avoids a potential collision.

In some aspects, the techniques described herein relate to a computer-implemented method or claim 22, wherein the cooperative navigation solution includes cooperative cruise control information.

In some aspects, the techniques described herein relate to a computer-implemented method, wherein the cooperative navigation solution includes cooperative adaptive lane keeping information.

In some aspects, the techniques described herein relate to a computer-implemented method, wherein the cooperative navigation solution includes cooperative collision avoidance information.

In some aspects, the techniques described herein relate to a computer-implemented method, wherein the roadside communication devices include a road side unit (RSU).

In some aspects, the techniques described herein relate to a computer-implemented method, wherein the roadside communication devices include a smart traffic light (STL).

In some aspects, the techniques described herein relate to a computer-implemented method, wherein the roadside communication devices include a smart traffic sign (STS).

In some aspects, the techniques described herein relate to a computer-implemented method, wherein the roadside communication devices include an automated traffic management (ATM) system.

In some aspects, the techniques described herein relate to a computer-implemented method, wherein the vehicle parameters include a vehicle length.

In some aspects, the techniques described herein relate to a computer-implemented method, wherein the vehicle parameters include a vehicle position.

In some aspects, the techniques described herein relate to a computer-implemented method, wherein the vehicle parameters include a heading angle.

In some aspects, the techniques described herein relate to a computer-implemented method, wherein the vehicle parameters include a lane identity of the vehicle.

In some aspects, the techniques described herein relate to a computer-implemented method, wherein the vehicle parameters include a turn identification of the vehicle.

In some aspects, the techniques described herein relate to a computer-implemented method, wherein the communication system includes an autonomous intersection management system.

In some aspects, the techniques described herein relate to a computer-implemented method, wherein the plurality of vehicle parameters include LIDAR data.

In some aspects, the techniques described herein relate to a computer-implemented method, wherein the plurality of vehicle parameters include RADAR data.

In some aspects, the techniques described herein relate to a computer-implemented method, wherein the plurality of vehicle parameters include camera data.

In some aspects, the techniques described herein relate to a computer-implemented method, further including controlling the autonomous vehicle using the cooperative navigation solution.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1A illustrates a system block diagram of a system for performing collision avoidance, according to implementations of the present disclosure.

FIG. 1B illustrates a system block diagram of a system for performing collision avoidance, according to implementations of the present disclosure.

FIG. 2A illustrates a flow chart of a method for performing collision avoidance, according to implementations of the present disclosure.

FIG. 2B illustrates a flow chart of a method for performing collision avoidance, according to implementations of the present disclosure.

FIG. 3A illustrates a system including cooperative highly automated vehicles with cooperative collision avoidance, cooperative cruise control, and cooperative lane-keeping, according to implementations of the present disclosure.

FIG. 3B illustrates a system including cooperative highly automated vehicles with cooperative collision avoidance, cooperative cruise control, cooperative lane-keeping, GPS, and RADAR, according to implementations of the present disclosure.

FIG. 4 illustrates a system including cooperative highly automated vehicles with cooperative collision avoidance, cooperative cruise control, cooperative lane-keeping, GPS, LIDAR, RADAR, and a camera, according to implementations of the present disclosure.

FIG. 4 illustrates a method of cooperative navigation, according to implementations of the present disclosure.

FIG. 5 is an example computing device.

FIG. 6 illustrates an overview of simulation scenario of a smart intersection including a roadside unit (RSU), a smart traffic light (STL), and autonomous intersection management (AIM).

FIG. 7 illustrates results of a simulation of an example implementation of the present disclosure, showing that an example actor and ego vehicle do not collide based on different velocity profiles.

FIG. 8 illustrates results of a simulation of an example implementation of the present disclosure including AIM devices, showing that an example actor and ego vehicle do not collide based on different velocity profiles.

FIG. 9 illustrates results of a results of a simulation of an example implementation of the present disclosure including AIM, STL, and cooperation.

FIG. 10 illustrates an example analysis of a first actor in a simulation, according to an implementation of the present disclosure.

FIG. 11 illustrates an example analysis of a second actor in a simulation, according to an implementation of the present disclosure.

FIG. 12 illustrates an example analysis of a third actor in a simulation, according to an implementation of the present disclosure.

FIG. 13 illustrates velocity tracking results for simulations of different cooperation scenarios, including V2V, cooperation, V2V and AIM cooperation, and V2V, AIM, and STL cooperation.

FIG. 14 illustrates attributes of example sensors and data sources that can be used in cooperative navigation systems, according to implementations of the present disclosure.

FIG. 15A illustrates examples of near space and far space navigation, according to implementations of the present disclosure.

FIG. 15B illustrates examples of near space and far space navigation, according to implementations of the present disclosure.

FIG. 16 illustrates threats and vulnerabilities of different sensors and sources of information that can be used in implementations of the present disclosure.

FIG. 17 illustrates an example of radar interference at a smart intersection, according to implementations of the present disclosure.

FIG. 18 illustrates an example simulation of a smart intersection, according to implementations of the present disclosure.

FIG. 19 illustrates a schematic of conflict points in an intersection, according to implementations of the present disclosure.

FIG. 20 illustrates a table of static and dynamic variables that can be simulated, according to implementations of the present disclosure.

FIG. 21 illustrates a simulation of velocity as a function of time for jamming scenarios, according to an implementation of the present disclosure.

FIG. 22 illustrates a simulation of steering angle as a function of time for jamming scenarios, according to an implementation of the present disclosure.

FIG. 23 illustrates a simulation of acceleration as a function of time for jamming scenarios, according to an implementation of the present disclosure.

FIG. 24 illustrates a simulation of highly automated vehicles including positions as a function of time, according to an implementation of the present disclosure.

FIG. 25 illustrates a simulation of highly automated vehicles including positions as a function of time including jamming and interference scenarios, according to an implementation of the present disclosure.

FIG. 26 illustrates a simulation result showing safety where patchy information was provided for actor 2, according to an implementation of the present disclosure.

FIG. 27 illustrates a simulation result showing velocity, where patchy information was provided for actor 2, according to an implementation of the present disclosure.

FIG. 28 illustrates attributes of an ego vehicle under different simulation scenarios, according to implementations of the present disclosure.

FIG. 29 illustrates simulation results showing velocity as a function of time for different scenarios, according to implementations of the present disclosure.

FIG. 30 illustrates simulation results showing steering angle as a function of time for different scenarios, according to implementations of the present disclosure.

FIG. 31 illustrates simulation results showing acceleration as a function of time for different scenarios, according to implementations of the present disclosure.

FIG. 32 illustrates simulation results showing acceleration as a function of time for different scenarios, according to implementations of the present disclosure.

FIG. 33 illustrates simulations of cooperative collision avoidance in threat scenarios where AIM and STL are jammed by an attacker, according to implementations of the present disclosure.

FIG. 34 illustrates simulations of cooperative collision avoidance in threat scenarios where STL is jammed by an attacker, according to implementations of the present disclosure.

FIG. 35A illustrates simulations of cooperative collision avoidance in threat scenarios where all communication channels are active, according to implementations of the present disclosure.

FIG. 35B illustrates cooperative cruise control velocities in threat scenarios, according to implementations of the present disclosure.

FIG. 36 illustrates a comparison of analyses of ego vehicles in different threat scenarios with different driving strategies for HAVs at a signal-free smart intersection, according to implementations of the present disclosure.

FIG. 37A illustrates lead vehicle velocity in an example simulated scenario, according to implementations of the present disclosure.

FIG. 37B illustrates simulated cooperative lane keeping results in different threat scenarios, according to implementations of the present disclosure.

FIG. 38 illustrates example conflict points at a simulated intersection, according to implementations of the present disclosure.

FIG. 39 illustrates example static and dynamic variables, according to implementations of the present disclosure.

FIG. 40A illustrates a schematic of a conflict point between an ego and actor vehicle, according to an example implementation of the present disclosure.

FIG. 40B illustrates a schematic of a conflict between an ego vehicle and actor vehicle, according to an example implementation of the present disclosure.

FIG. 41 illustrates spacing control between vehicles, according to an example implementation of the present disclosure.

FIG. 42 illustrates the relationship between an ego vehicle and actor vehicles, according to implementations of the present disclosure.

FIG. 43 illustrates a schematic of two vehicles in a simulated intersection, according to implementations of the present disclosure.

FIG. 44 illustrates a schematic of two vehicles in a simulated lane of traffic, according to implementations of the present disclosure.

FIG. 45A illustrates simulation results showing acceleration as a function of time for different scenarios, according to implementations of the present disclosure.

FIG. 45B illustrates simulation results showing steering angles as a function of time for different scenarios, according to implementations of the present disclosure.

FIG. 46 illustrates simulation results for different jamming scenarios, according to implementations of the present disclosure.

FIG. 47 illustrates simulation results showing velocity as a function of time for different jamming scenarios, according to implementations of the present disclosure.

FIG. 48 illustrates simulation results showing steering angle as a function of time for different jamming scenarios, according to implementations of the present disclosure.

FIG. 49 illustrates simulation results showing acceleration as a function of time for different jamming scenarios, according to implementations of the present disclosure.

FIG. 50 illustrates simulation results showing acceleration as a function of time for different jamming scenarios, according to implementations of the present disclosure.

FIG. 51 illustrates simulation results for an ego vehicle under different jamming scenarios, according to implementations of the present disclosure.

FIG. 52 illustrates an example algorithm for performing cooperative collision avoidance.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for performing navigation and collision avoidance between autonomous vehicles in intersections, it will become evident to those skilled in the art that the implementations are not limited thereto, but are applicable for preventing collisions between other vehicle types, as well as preventing collisions between vehicles in locations other than intersections.

Described herein are systems and methods for performing navigation and control of autonomous vehicles at an intersection.

The systems and methods described herein can be used to implement cooperative navigation strategies with partially or completely autonomous vehicles. In existing systems, partially or completely autonomous vehicles typically perform self-driving without using cooperative navigation. These autonomous vehicles can be considered “self-contained”—the vehicle acquires the information it needs to navigate from a variety of sensors, and makes decisions without receiving information from other sources or vehicles. These “self-contained” autonomous vehicles are unable to take advantage of the additional information and navigation strategies that could be acquired by receiving information from other sources and/or cooperating with other vehicles.

In contrast, other existing systems for autonomous vehicles include vehicles that are centrally controlled by a system that monitors the position and status of multiple vehicles in that system, and issues commands to the vehicles to steer navigate. These centrally controlled systems are vulnerable to disruption because the vehicles are dependent on the central controller to determine how to navigate. In other words, these autonomous vehicles are not “self-contained.”

The systems and methods described herein include cooperative systems and methods that allow autonomous vehicles to navigate autonomously and to interact with other autonomous vehicles and various sensors that can be part of road infrastructure. The systems and methods described herein can generate a cooperative navigation solution for an autonomous vehicle using a communication system, traffic information, and/or vehicle parameters that can optionally be sensed using one or more sensors. The autonomous vehicle is optionally controlled based, at least in part, on the cooperative navigation solution. This allows for the benefits of cooperative navigation strategies to be incorporated into systems with autonomous vehicles.

In particular, implementations of the present disclosure include cooperative navigation methods that can be used in conjunction with AIM (Autonomous Intersection Management), RSU's (RoadSide Units), STL's (Smart Traffic Lights), and OBU's (vehicle onboard units) and CAV's (connected autonomous vehicles) that can be connected by infrastructure. The example implementation described herein can be used by autonomous vehicles to navigate and communicate with smart infrastructure.

Cooperative navigation strategies that include autonomous vehicles and smart infrastructure can increase the safety and capacity of intersections, including smart intersections. Additionally, implementations of the present disclosure can be used for both autonomous and non-autonomous vehicles, as well as in situations where only some vehicles are configured to cooperate (i.e., are non-cooperative). Implementations of the present disclosure using smart infrastructure can increase the safety and efficiency of autonomous vehicles in situations where obstacles or other vehicles are beyond visual range of each other, or beyond visual range of the intersection.

Implementations of the present disclosure can be used for collision avoidance in traffic situations with and without traffic signals. In situations with and without traffic signals, different components of the system can be used. For example, in an unsignalized intersection, the autonomous vehicle can use an OBU, while in a signalized intersection the autonomous vehicle can use an RSU, OBU, AIM system, and/or STL's.

Implementations of the present disclosure include a cooperative navigation strategy focusing on Cooperative Collision Avoidance (CCA) for CAV's. Smart infrastructure information can be used with CAV's in a smart city environment or other environments including smart infrastructure. The present disclosure contemplates that smart infrastructure can include RSUs, an AIM systems, STL, and Smart traffic Signs (STS). The present disclosure contemplates that smart infrastructure can include any or all of these components, and that the components can be placed at any location along a roadway (e.g., at an intersection, between intersections, along a highway, etc.).

Implementations of the present disclosure are configured to avoid collisions between CAVs at smart intersections. The cooperative navigation methods and systems disclosed herein can include a navigation system that can exchange data, on its current state and environmental parameters to evaluate its decision and position for safe operation. The navigation system can be used to provide position navigation, and timing (PNT) guidance to autonomous vehicles.

Implementations of the present disclosure can use information from RSU, STL, AIM, and OBU to generate an optimized velocity profile to cross the smart intersection.

For example, the vehicle control system can be configured to receive traffic information from the communication system. The traffic information from the communication system can include information from roadside communication and computing devices and/or information from other vehicles.

The information received from the roadside communication and computing devices can include information from smart infrastructure devices, including road side units, smart traffic lights, smart traffic signs, and automated traffic management systems. The road side units, smart traffic lights, smart traffic signs, and automated traffic management systems can be part of the communication system. For example, any or all of the roadside communication and computing devices can be connected by a wired or wireless network. Another non-limiting example of a roadside communication and computing device that can be part of the communication system is an AIM system.

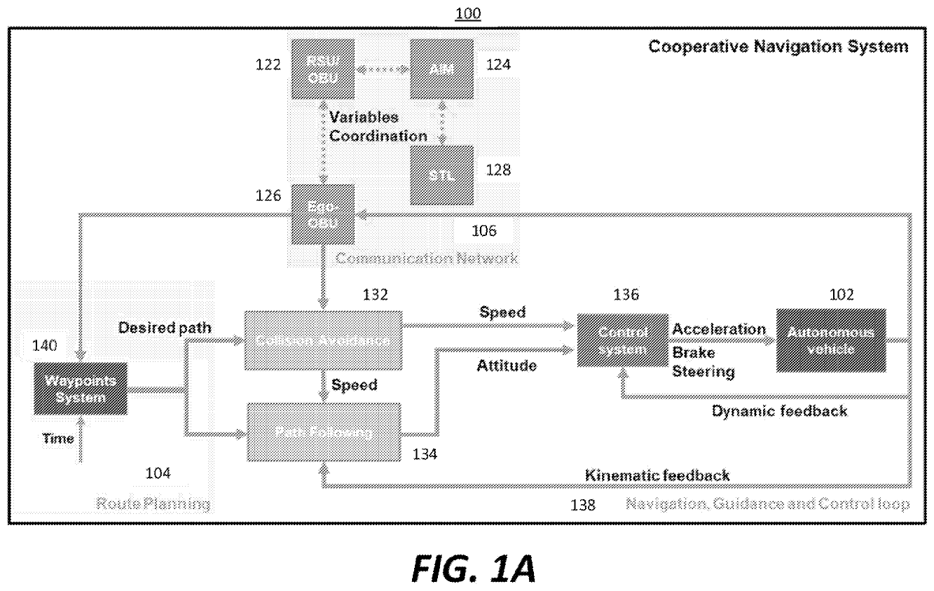

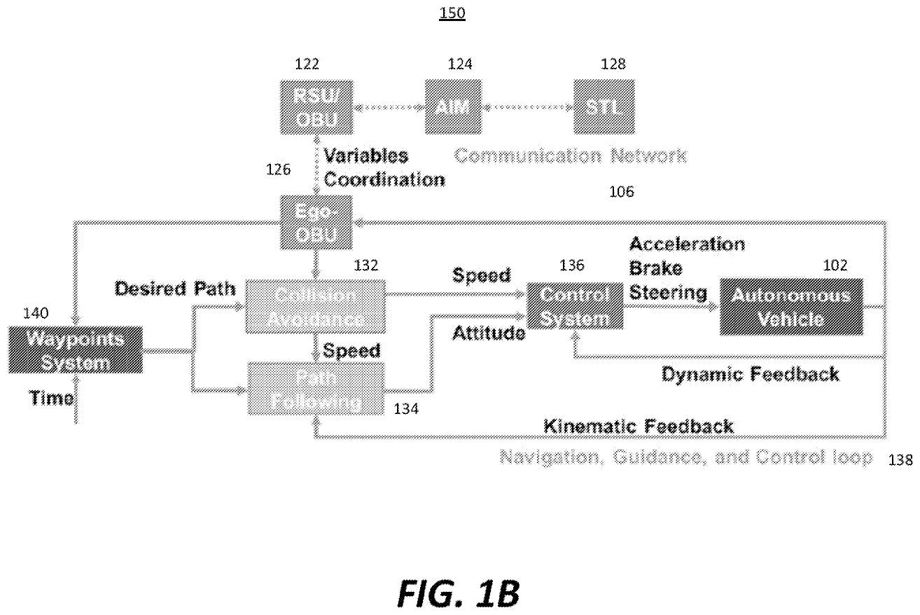

With reference to FIG. 1A, implementations of the present disclosure include systems for performing cooperative navigation with autonomous vehicles.

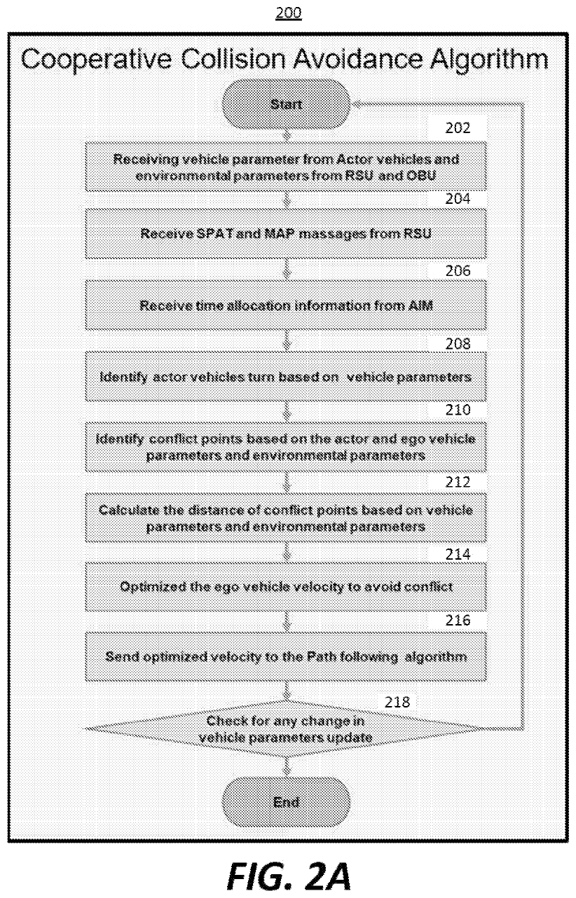

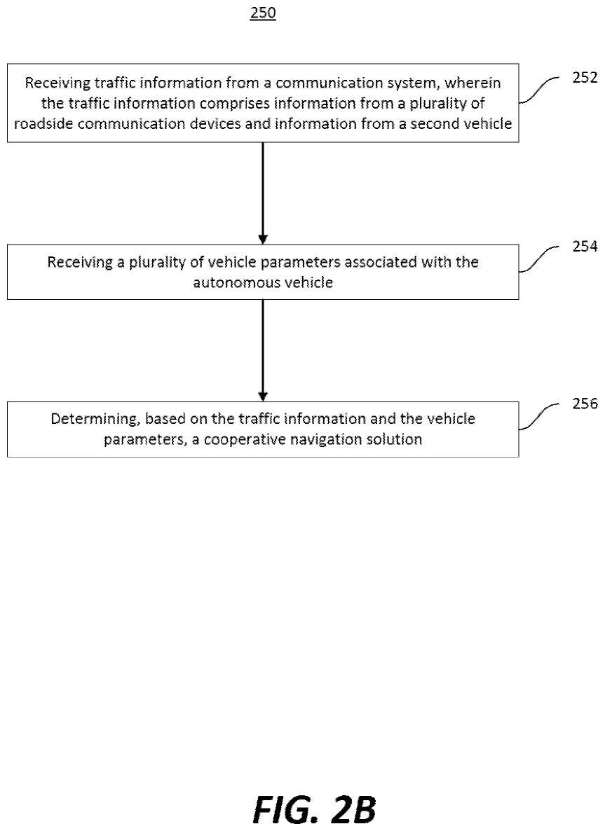

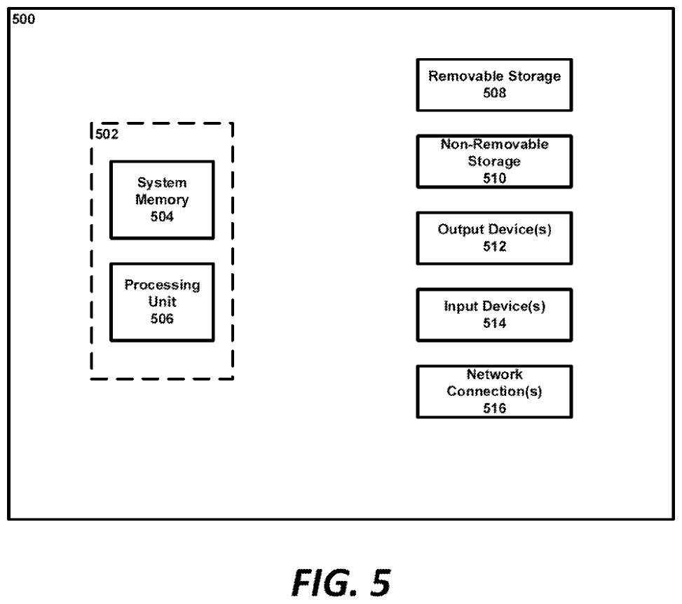

The system 100 shown in FIG. 1A includes an autonomous vehicle 102, a route planning system 104, a communication system 106, and a vehicle control system 136. The vehicle control system 136 can be operably coupled to the autonomous vehicle 102, and, for example, can be configured to control the autonomous vehicle 102. Optionally, any or all of the autonomous vehicle 102, route planning system 104, communication system 106, and vehicle control system 136 can include a computing device, for example the computing device 500 illustrated in FIG. 5. The vehicle control system 136 can be configured to perform methods of cooperative navigation, including the methods described with reference to FIG. 2A and FIG. 2B.

In some implementations, the system 100 can be configured so that any or all of the route planning system 104, communication system 106, and/or vehicle control system 136 are positioned in/on the autonomous vehicle 102, or attached to the autonomous vehicle 102. The systems and methods described herein can be configured to allow for cooperative navigation where one or more autonomous vehicles 102 are in traffic, and the autonomous vehicles perform cooperative navigation to avoid collisions between themselves and/or any non-autonomous vehicles. As used herein, cooperative navigation includes navigation systems and methods that may not rely on centralized traffic control, and can be performed onboard the autonomous vehicles 102.

Still with reference to FIG. 1A, the communication system 106 can optionally include roadside units and/or onboard units. As used herein, an “onboard unit” or OBU refers to a communication or control device that is located “onboard” a vehicle. The communication system 106 can further include Autonomous Intersections Management (AIM) system 124, and smart traffic lights (STL) 128. The communication system 106 can be configured to interface with the “ego” OBU 126, which can be located on the autonomous vehicle 102.

Still with reference to FIG. 1A, the navigation guidance and control loop 138 can include a collision avoidance system 132, a path following system 134, and a control system 136. The control system 136 can be configured to receive collision avoidance and path following information (e.g., speed and attitude) from the collision avoidance and path following systems, and convert the speed and attitude into acceleration, braking, and steering controls for the autonomous vehicle 102. The control system 136 can also be configured to determine, based on the traffic information and the vehicle parameters, a vehicle velocity, where the vehicle velocity represents a speed that will avoid a collision between the autonomous vehicle and another vehicle or other obstacle. Alternatively or additionally, the vehicle parameters can include information about the location or movement of the vehicle. As a non-limiting example, the vehicle parameters can include a heading angle, lane identity of the vehicle, and/or turn identification of the vehicle.

Again with reference to FIG. 1A, the collision avoidance system 132 and path following system 134 can receive inputs from a waypoints system 140. The waypoints system can determine a desired path for the autonomous vehicle 102 that can be an input to the collision avoidance system 132 and path following system 134. As shown in FIG. 1A, the collision avoidance system 132 and path following system 134 can also exchange information (for example, speed information for the autonomous vehicle 102). The information received from other vehicles can include information about the characteristics (i.e., “vehicle parameters”) of those autonomous vehicles. The vehicle parameters can include information about any attribute of the vehicle. In some implementations of the present disclosure, vehicle parameters include information about the size of the vehicle, including the length, width, and height of the vehicle.

It should be understood that the use of other traffic management systems or smart infrastructure devices is contemplated by the present disclosure.

With reference to FIG. 1B, it should be understood that the communication system 106 can be configured so that information is exchanged along different paths or in different ways among the AIM system 124, STL 128, RSU/OBU 122 and ego OBU 126. In the example system 150 illustrated in FIG. 1B, the ego OBU 126 communicates with the RSU/OBU 122, which in turn communicates with the AIM system 124 and STL 128. But it should be understood that any part of the communication system 106 can be in communication with any other part of the communication system 106.

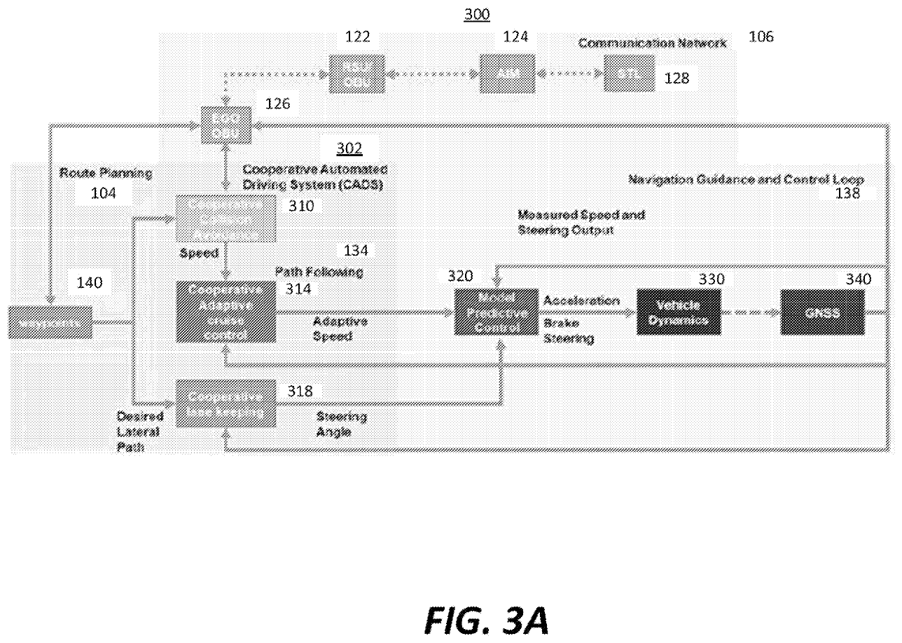

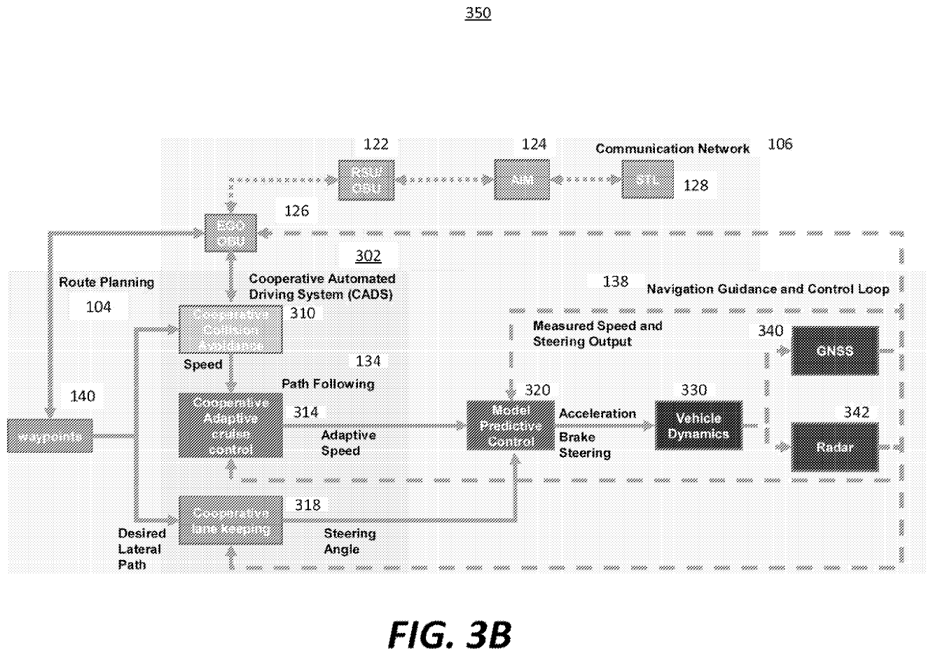

With reference to FIG. 3A, another example system 300 is illustrated according to another implementation of the present disclosure. The system 300 includes the communication system 106 and route planning system 104 described with reference to FIG. 1A. The system 300 further includes a cooperative automated driving system 302 that can include a cooperative collision avoidance system 310, a cooperative adaptive cruise control system 314, and a cooperative lane keeping system 318. The cooperative adaptive cruise control system 314 and cooperative lane keeping system 318 can optionally be part of a path following system 134. The system 300 can further include route planning system 104. In the system 300, the navigation guidance and control loop 138 can include a model predictive control system 320, a vehicle dynamics system 330 and a Global navigation satellite system (“GNSS system”) 340. A non-limiting example of a GNSS system 340 is a GPS system, but it should be understood that any system or sensor that can be used to locate a vehicle can be used in place of the GNSS system 340 or in addition to the GNSS system 340.

With reference to FIG. 3B, another system 350 is illustrated according to another implementation of the present disclosure. The system 350 includes the elements shown and described with reference to the system 300 in FIG. 3A. In FIG. 3B, the system 350 further includes a RADAR system or sensor 342 as part of the system 350.

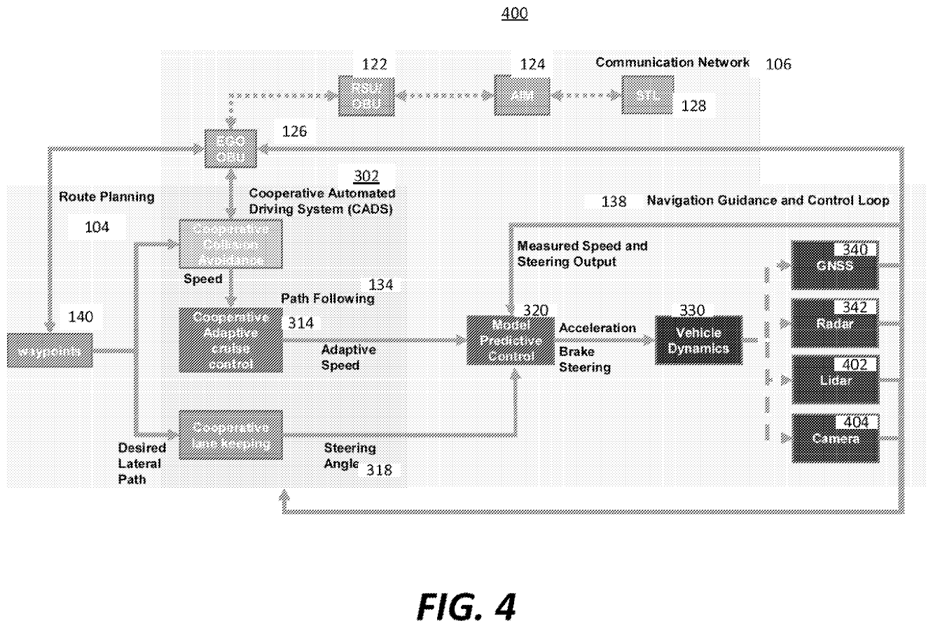

With reference to FIG. 4, another system 400 is illustrated according to another implementation of the present disclosure. The system 400 includes the elements shown and escribed with reference to the system 350 in FIG. 3B. The system 400 further includes a LIDAR sensor 402 and a camera sensor 404.

In some implementations, the RSU can be used for communication between vehicles and smart infrastructure. The RSU can use a dedicated short-range communication (DSRC) channel and can share environmental parameters, AIM, and STL information with vehicles present at that intersection.

In some implementations, the OBU can be a communication device used to exchange information with a vehicle to vehicle (V2V) and vehicle to infrastructure (V2I) using the DSRC channel. All vehicle parameters and information is shared via V2V communication.

In some implementations, the AIM can be an intersection management system that assigns time slots to the vehicles and manages intersection traffic light controller phase and time information.

In some implementations, the STL is the smart traffic light that can change phase and time information according to the traffic condition and density on the specific lane.

With reference to FIGS. 2A and 2B, the present disclosure includes methods of performing cooperative navigation. FIG. 2A illustrates a flow chart of a method 200 for performing collision avoidance, according to implementations of the present disclosure. The method can include receiving vehicle parameters at step 202.

At step 204, the method can include receiving information from smart infrastructure systems (including SPAT and MAP messages).

At step 206, the method can include receiving time allocation information. Optionally, the time allocation information can be obtained from smart infrastructure systems.

At step 208, the method can also include identifying vehicles.

At step 210, the method can include detecting conflict points, for example conflict points between any number of the vehicles identified in step 208. Optionally, the distance between the conflict points can be based on vehicle parameters and/or environmental parameters.

At step 212, the distance between the vehicle and the conflict points can also be determined. Optionally, the distance between the conflict points can be based on vehicle parameters and/or environmental parameters.

At step 214, the ego vehicle velocity can be optimized. Optionally, the optimization is performed based on the distance between the vehicle and the conflict points, and the vehicle parameters of the vehicle. As an example, the optimization can be an optimization that determines a speed of the vehicle that will avoid a collision at the conflict point.

At step 216, the method can further include adjusting the path of the vehicle based on the conflict points to avoid the conflict points.

At step 218, the method can further include providing the optimized velocity determined at step 216 to a control system. Optionally, the optimized velocity can be provided to a path following system/algorithm to steer the ego vehicle.

At step 218, the method can include repeating steps 202 through 216 any number of times. Optionally, the method can be repeated when there is a change in a vehicle parameter, in order to determine whether the new path and/or velocity of the vehicle will collide with any other vehicle.

With reference to FIG. 2B, another example method 250 for performing cooperative navigation is illustrated. The example method can be a computer-implemented method in some implementations of the present disclosure. The method 250 can be used for cooperative navigation of autonomous vehicles. A non-limiting example of an autonomous vehicle is a car, but it should be understood that the present disclosure can be used for other autonomous vehicles, for example trucks, trains, and/or aerial vehicles.

At step 252, the method includes receiving traffic information from a communication system. Optionally, the communication system can include any/all of the components of the computing device 500 shown in FIG. 5.

The traffic information can include information from a plurality of roadside communication devices and information from a second vehicle. As used herein, “roadside communication devices” can include any device that can be used to monitor traffic and/or communicate with vehicles in traffic. In some implementations, the roadside communication device(s) can include a road side unit (RSU). Alternatively or additionally, the roadside communication device(s) can include a STL and/or smart traffic sign (STS) Yet another non-limiting example of a roadside communication device is an automated traffic management (ATM) system. Still another non-limiting example of a roadside communication device is an autonomous intersection management system.

At step 254, the method can include receiving vehicle parameters associated with the autonomous vehicle. The vehicle parameters can include any information that relates to the position or orientation of the autonomous vehicle, as well as the physical properties of the autonomous vehicle. Non-limiting examples of vehicle parameters that can be used in implementations of the present disclosure include vehicle length, vehicle position, heading angle, a lane identity of the vehicle, and a turn identification of the vehicle.

Alternatively or additionally, the method can include measuring vehicle parameters using sensors. Example sensors include LIDAR, RADAR, and/or cameras. In some implementations, the vehicle parameters can include any or all of LIDAR data, RADAR data and/or camera data.

At step 256, the method can include determining, based on the traffic information and the vehicle parameters, a cooperative navigation solution. Optionally, the cooperative navigation solution can include a vehicle velocity. In some implementations, the vehicle velocity is a velocity that avoids a potential collision.

Alternatively or additionally, the cooperative navigation solution can include cooperative cruise control information. Alternatively or additionally, the cooperative navigation solution can include cooperative adaptive lane keeping information. Alternatively or additionally, the cooperative navigation solution comprises cooperative collision avoidance information. It should be understood that in different implementations of the present disclosure the cooperative navigation solution can include any combination of vehicle velocity, adaptive lane keeping information, cooperative cruise control information and/or collision avoidance information.

It should be appreciated that the logical operations described herein with respect to the various figures may be implemented (1) as a sequence of computer implemented acts or program modules (i.e., software) running on a computing device (e.g., the computing device described in FIG. 5), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 5, an example computing device 500 upon which the methods described herein may be implemented is illustrated. It should be understood that the example computing device 500 is only one example of a suitable computing environment upon which the methods described herein may be implemented. Optionally, the computing device 500 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 500 typically includes at least one processing unit 506 and system memory 504. Depending on the exact configuration and type of computing device, system memory 504 may be volatile (such as random access memory (RAM)), non-volatile (such as read-only memory (ROM), flash memory, etc.), or some combination of the two. This most basic configuration is illustrated in FIG. 5 by dashed line 502. The processing unit 506 may be a standard programmable processor that performs arithmetic and logic operations necessary for operation of the computing device 500. The computing device 500 may also include a bus or other communication mechanism for communicating information among various components of the computing device 500.

Computing device 500 may have additional features/functionality. For example, computing device 500 may include additional storage such as removable storage 508 and non-removable storage 510 including, but not limited to, magnetic or optical disks or tapes. Computing device 500 may also contain network connection(s) 516 that allow the device to communicate with other devices. Computing device 500 may also have input device(s) 514 such as a keyboard, mouse, touch screen, etc. Output device(s) 512 such as a display, speakers, printer, etc. may also be included. The additional devices may be connected to the bus in order to facilitate communication of data among the components of the computing device 500. All these devices are well known in the art and need not be discussed at length here.

The processing unit 506 may be configured to execute program code encoded in tangible, computer-readable media. Tangible, computer-readable media refers to any media that is capable of providing data that causes the computing device 500 (i.e., a machine) to operate in a particular fashion. Various computer-readable media may be utilized to provide instructions to the processing unit 506 for execution. Example tangible, computer-readable media may include, but is not limited to, volatile media, non-volatile media, removable media and non-removable media implemented in any method or technology for storage of information such as computer readable instructions, data structures, program modules or other data. System memory 504, removable storage 508, and non-removable storage 510 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 506 may execute program code stored in the system memory 504. For example, the bus may carry data to the system memory 504, from which the processing unit 506 receives and executes instructions. The data received by the system memory 504 may optionally be stored on the removable storage 508 or the non-removable storage 510 before or after execution by the processing unit 506.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1

An example implementation of the present disclosure includes a cooperative navigation strategy for connected autonomous vehicles operating at smart intersections. The example implementation can achieve cooperative collision avoidance for enhancing the safety and capacity of the intersection. The example implementation was evaluated with cooperative connected autonomous vehicles operating simultaneously with non-cooperative autonomous vehicles. In the example implementation, beyond visual range scenarios were evaluated to reduce the vulnerable situations. Beyond visual range, information is implemented by using the data from the roadside units, autonomous intersection management system, smart traffic lights, and onboard units. MATLAB/Simulink environments were used to validate the experimental implementation in a study of a simulation. The simulation results show the separation time within the set upper and lower bounds. That can ensure that the ego vehicle does not collide with others at the intersection. The cooperative collision avoidance algorithm guides the ego vehicle as soon as the ego vehicle comes in the range of the intersection service area, which increases the safety and capacity of the intersection. This strategy is comfortably used for both an unsignalized and signalized intersection. In an unsignalized intersection scenario, the ego vehicle uses an onboard unit. In signalized intersection scenario, the ego vehicle uses a roadside unit, onboard unit, autonomous intersection management system, and smart traffic lights. The example implementation can be used to implemented connected autonomous vehicles that can utilize the information from smart infrastructure devices.

Recent advancements in the automotive industry focus on autonomous vehicles. Technology innovations such as Vehicle to Vehicle (V2V) communication, Vehicle to Infrastructure (V2I) communication, Vehicle to Cloud (V2C), Vehicle to Pedestrian (V2P) communication, and guidance, navigation, and control system can provide a safe environment for Connected Autonomous Vehicles (CAVs) and all road users. Khayatian et al. (2020). As an example, Smart Columbus is one of the major projects supported by the U.S. Department of Transportation (USDOT) to develop Columbus as a model smart connected city for CAV's to improve people's quality of life, economic growth, sustainability, and safety Cocks and Johnson (2021). Systems for traffic control including CAV's can be categorized into two major domains: (i) infrastructure development approach and (ii) vehicular control approach for connected autonomous vehicles. Technological development in infrastructure related to the automobile industry can include roadside computing and communication devices including RSU's, STL's, STS's, AIM systems, Cloud Storage and Connectivity, and/or Automated Traffic Management (ATM) System. An RSU is an edge computing device that establishes the connection of communication between vehicles and infrastructure. RSU's can use the Dedicated Short Range Communication (DSRC) channel to exchange information between infrastructure and vehicles. Vehicular control approach-based navigation can have many subsystems of the automatic driving systems (way-points positioning system, path planning system, lane-keeping system, etc.) that make vehicles smart enough to operate safely in a vulnerable environment. All subsystems can be used to convert a vehicle into a Highly Automated Vehicle (HAVs) and/or a Highly Smart Vehicle (HSVs) to operate in vulnerable environments or situations.

From the above discussion, it is concluded that the efforts were made in the direction of (i) infrastructure development approach, which is developed only for the smart intersection, and (ii) vehicular control approach, which only works for the un-signalized intersection using V2” “V communication. Intersection management strategies use a reservation approach for CAVs, compromising the intersection's capacity. On the other hand, the vehicular navigation strategies mostly use the game theory approach for CAVs at the intersection which compromises safety where beyond visual information is not available Khayatian et al. (2020).

The example systems and methods described herein can eliminate the downsides of systems and methods that rely solely on information from vehicles or information from smart intersections. The example implementations can use V2I and V2V information to decide the efficient realization of systems in the smart intersection and non-smart intersections. It can reduce the hazards due to hacking and system failure in the vulnerable environment and enhance the safety, and capacity of CAVs operating at smart intersections. The rapid development of smart cities required the proposed cooperative navigation strategy for CAV's operating at the smart intersection.

In the example implementation, safety can be achieved using infrastructure devices and vehicle sensors simultaneously by a cooperative navigation framework. Moreover, in the example implementation, capacity and safety can be achieved by velocity optimization in a cooperative collision avoidance algorithm.

Operations over intersections can be particularly important because of the large number of merge, diverge and cross conflict points. The present example includes a cooperative position, navigation, and timing (PNT) solution for the ego vehicle based on other vehicles operating at the same intersection. The example navigation strategy includes performing collision avoidance at the smart intersection. In the example implementation, the smart intersection can be equipped with RSU, AIM, and STL. Due to the presence of the mentioned devices, the SPaT, intersection parameters, MAP, time-slots, and other lane vehicle information are available for the ego vehicle. In the example implementation, all actor vehicles can be non-cooperative vehicles. Actor vehicles only share their velocity profiles and do not respond to the other vehicle's actions. The ego vehicle uses the information from all other vehicles. The actor vehicle's velocity profile and distance can be used to generate the ego vehicle velocity profile. This information can be used to calculate the other vehicle's future path with the time of arrival at the conflict point to find potential conflicting situations. Problem formulation has been done based on conflict points, intersection parameters, and CAV's future path.

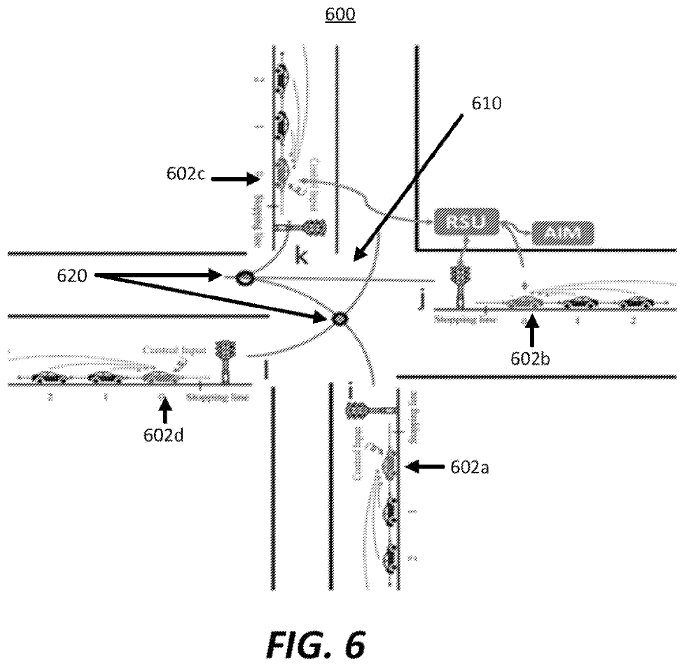

FIG. 6 shows an intersection scenario 600 that has the three vehicles that are at the intersection 610. in each lane and all have different directions to move that is straight, right, and left turn. The leading vehicle in the i lane is the ego CAV 602a that has to follow the left turn path. A vehicle 602b in the j lane is another CAV that has to follow the straight path. CAV in the k lane 602c has to follow the right turn, and CAV in l lane 602d has to follow the left turn. The intersection scenario 600 shown in FIG. 6 generates two conflict points 620 concerning the latitude and longitude positions of the ego CAV 602a, while in the time frame, there are three conflicting situations. The actor vehicles are connected and automated, but they may not have beyond visual range cooperativeness. The ego CAV 602a can share information such as forward and rear lengths of the GPS receiver point, turn indication, the width of the vehicle, the height of the vehicle, the current position of the vehicle in terms of latitude and longitude, the velocity at which its approaching intersection, and heading angle of the vehicle. In the example studied, it is assumed that all perception sensors were performing well and generating relative positioning and speed information of other vehicles and their surrounding obstacles. The scenario simulation only deals with the leading vehicles in lanes, but the proposed solution can be implemented for other vehicles in each lane.

In the example study, a dynamic model of the vehicle has been taken into account in the simulation framework. The tire modeling is used to depict the nonlinear behavior of the vehicles Bian et al. (2014). The effects of tire slip with steering angle also considered for the evaluation. (1) is the 3DOF mathematical modeling of CAVs operating at the intersection. Dynamic modeling is referred and modeled according to the SAE J670e standards Code (1995).

$$\{ \begin{matrix}I \ddot{ϕ} = {aP}_{if}^{n} δ + {bF}_{ilf}^{n} - {bF}_{ilr}^{n} \\ m ( {\dot{V}}_{iy}^{in} + {V}_{ix}^{n} \dot{ϕ} ) = δ {P}_{if}^{n} + {F}_{ilf}^{n} + {F}_{ilr}^{n} \\ m ( {V}_{ix}^{in} + {V}_{iy}^{n} \dot{ϕ} ) = {P}_{if}^{n} + {P}_{ir}^{n} + {F}_{ilr}^{n} δ \\ {x}_{i}^{n} = {V}_{ix}^{n} cos ϕ - {V}_{iy}^{n} sin ϕ \\ {y}_{i}^{n} = {V}_{iy}^{n} cos ϕ + {V}_{ix}^{n} sin ϕ\end{matrix}$$

Where I is the inertia of the vehicle, φ is the yaw angle, a and b are the forward and rear length of the vehicle from the center of gravity, P_{f} and Pᵣ are longitudinal forces on the front and rear tires, F_{lf} and Fₗᵣ are lateral forces on the front and rear tires, m is the mass of the vehicle, Vₓ and V_{y} are longitudinal and lateral velocities, x and y are longitudinal and lateral positions and δ is the steering angle. ‘i’ represents the lane ID of the intersection, and ‘n’ represents the vehicle ID. Similar indexes were used for other actors vehicle dynamics, such as j, k, and l for different lanes and n=1, 2, 3 . . . , n for different vehicles. The term

$$δ {P}_{if}^{n} and δ {F}_{ilf}^{n}$$

in (1) represent the effect of vehicle side-slip. It is necessary because the vehicle operating at the intersection needs to take a 90-degree turn. Since sideslip is the product of lateral force with steering angle as shown in (1). Therefore, as the velocity of the vehicle increases the side slip also increases Kim and Ryu (2011). Precise steering command signals depend on the side-slip of vehicle. It should be understood that these example formulas and models for the vehicles are intended only as non-limiting examples.

In the example implementation, the intersection is modeled in terms of conflict points for each lane and path taken by the vehicle. The selection of the way-points is crucial for the accurate calculation of conflicting situations. As shown in FIG. 6, if the selected consecutive way-points are far apart, the system may not calculate highlighted conflict points. Since all vehicles can be connected, the ego CAV 602a can develop a set of way-points for each leading vehicle that can create a conflicting situation. Hence, every next-way point is spaced by the length of the vehicle. Equation (2) shows the number of conflict points in a path for a particular vehicle.

$$\{ \begin{matrix}q = \frac{{R}_{l} θ}{{L}_{i}^{n}} \\ {C}_{q}^{i} = {Γ}_{i}^{0} + {qL}_{i}^{n}\end{matrix} \qquad ( 2 )$$

Where Rₗ is the left turn radius of the intersection.

$${Γ}_{i}^{n}$$

is a position where the intersection starts.

$${L}_{i}^{n}$$

is the length of the vehicle, and

$${C}_{q}^{i}$$

is the set of waypoints generated to follow the path. q is the number of conflict points for the vehicle. As soon as the vehicle leaves one conflict point, it can enter the next conflict point. This strategy provides all possible conflicting points in a path. This can provide an advantage over techniques that produce only a limited number of conflict points in an intersection [Milo (2020)], and [Cocks and Johnson (2021)]. Equation (2) can generate conflict points for any configuration of intersection. The value of the θ range for the path is from 0 to 90°. Therefore, the example modeled intersection of FIG. 6 is in a perfect cross configuration, however implementations of the present disclosure can work for any type of intersection with the ability to avoid collision.

Navigation based on smart infrastructure can rely on devices that share data using the DSRC communication channel. This type of guidance is prone to cyber security threat issues. While navigation using onboard sensors does not provide beyond visual range information. However, both pieces of information are necessary for operations at the smart intersection. The example cooperative navigation strategy can use both (i) AIM, STL, and RSU information and (ii) feedback from sensors simultaneously, to provide safe and effective cooperative navigation at the intersection of smart cities. A signalized intersection scenario is described herein that has a single incoming lane on each side of the intersection as shown in FIG. 6. The number of vehicles in each lane is represented by a different group of vehicles as shown in FIG. 6. The formulation maintains a safe distance within the same group of vehicles and simultaneously avoid conflicts between different groups of vehicles. FIG. 6 shows the potential conflict points over the signalized intersection of the simulation scenario highlighted by a circle. FIG. 1B shows an overview of cooperative navigation, guidance, and control system 100 that depicts the flow and type of information that can be exchanged between RSU and OBUs of the vehicle. The vehicle control system 136 can use all actor vehicles, ego vehicle, and environmental parameters to calculate optimized velocity for the ego vehicle which avoids conflict in the vulnerable scenario. Velocity is used by the path following block to generate actuation command to vehicle dynamics block. Current state values are feedback to path following and send to OBU for cooperation with other vehicles. The cooperative collision avoidance algorithm uses other vehicle information such as position, velocity, length, width, heading angle, lane identity, and turn indication of vehicle. The cooperative collision avoidance algorithm resolves the conflict point between all leading vehicles from each lane and within the lane vehicle.

Collision avoidance algorithms (e.g., Huang et al. (2021), Bifulco et al. (2021), and Wang et al. (2021)) can be implemented as part of an onboard computing system. The onboard computing system can access information from roadside communications devices such as AIM, RSU, and STL available at a smart intersection. If two of the vehicles have a common 3D positioning such as [lat, long, time] at any timestamp they will collide. The cooperative collision avoidance system calculates the desired velocity to avoid conflicts. Once the algorithm optimizes the velocity, it can share the velocity to the path following algorithm and repeat the process throughout the simulation. This can generate the velocity profile at which the vehicle follows its path across the intersection. The surrogate optimization fulfills the two basic requirements of real-time optimization in automotive applications. Surrogate optimizations can require less time to optimize a solution and can find an optimal solution for the problem. In the proposed framework, SPaT information from STL, Pᵢ, and turn indication Iᵢⁿ from the vehicle is the standard requirement to optimize the ego vehicle velocity. Surrogate optimizes the function within a bounded range defined by the scenario. The algorithm constructs a surrogate as an interpolation of the objective function by using a radial basis function (RBF) interpolator Xu et al. (2018). RBF interpolation has several convenient properties that make it suitable for constructing a surrogate. Evaluating an RBF interpolator can be performed quickly, which can be an essential requirement for an automotive system.

The objective function defines in terms of the time of arrival, traveling time, and phase time of the signal. In (3)

$$' {T}_{i}^{n} \text{"}$$

is the time vehicle takes to travel from its current position to the next waypoint.

$$\{ {T}_{i}^{n} = \frac{{c}_{q}^{i} - {x}_{i 1}^{n}}{{V}_{i}^{n}} + {τ}_{i}^{n} \qquad ( 3 )$$

Where

$${x}_{i}^{n} , {V}_{i}^{n} , {τ}_{i}^{n}$$

represent the current position, velocity and minimal separation time of CAV respectively.

$${τ}_{i}^{n}$$

is also the function of vehicle parameters as a vehicle having a larger size in length needs more separation time than a shorter vehicle. So the conflict situation can arise when

$${C}_{q}^{i} = {C}_{q}^{j}$$

at any particular timestamp.

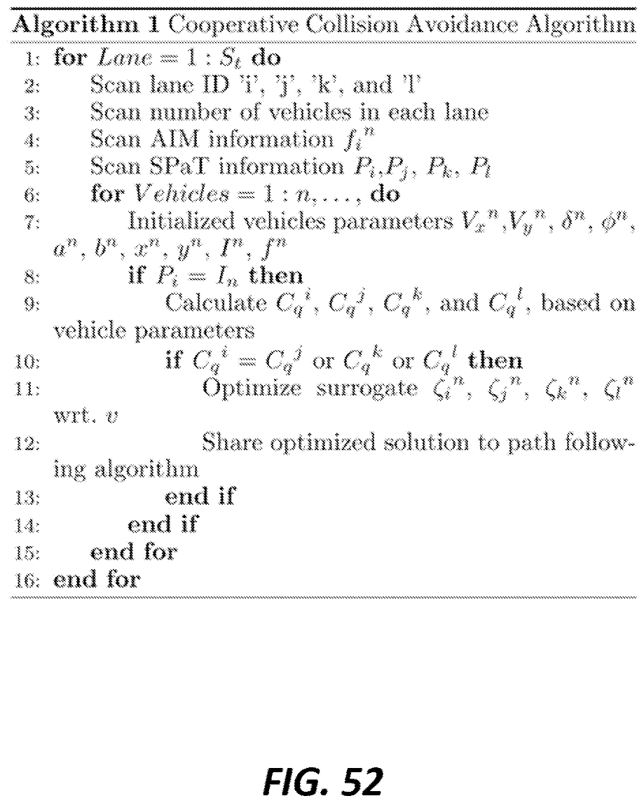

Let ζ be the difference in time of arrival from ego vehicle to another vehicle at the intersection. Therefore, the objective function in Eq. (4) is used to minimize the ζ for all the vehicles at the intersection by using information from AIM, RSU, and OBUs. FIG. 52 illustrates an example algorithm for performing cooperative collision avoidance.

$$\{ \begin{matrix}{ζ}_{i}^{n} = \vert {e}^{\vert {I}_{i}^{n} - {P}_{i} \vert} ( {f}_{i}^{n} + {T}_{i}^{n} ) - {e}^{\vert {I}_{i}^{n + 1} - {P}_{i} \vert} ( {f}_{i}^{n + 1} + {T}_{i}^{n + 1} ) \vert \\ {ζ}_{j}^{n} = \vert {e}^{\vert {I}_{i}^{n} - {P}_{i} \vert} ( {f}_{i}^{n} + {T}_{i}^{n} ) - {e}^{\vert {I}_{j}^{n} - {P}_{j} \vert} ( {f}_{j}^{n} + {T}_{j}^{n} ) \vert \\ {ζ}_{k}^{n} = \vert {e}^{\vert {I}_{i}^{n} - {P}_{i} \vert} ( {f}_{i}^{n} + {T}_{i}^{n} ) - {e}^{\vert {I}_{k}^{n} - {P}_{k} \vert} ( {f}_{k}^{n} + {T}_{k}^{n} ) \vert \\ {ζ}_{l}^{n} = \vert {e}^{\vert {I}_{i}^{n} - {P}_{i} \vert} ( {f}_{i}^{n} + {T}_{i}^{n} ) - {e}^{\vert {I}_{i}^{n + 1} - {P}_{i} \vert} ( {f}_{l}^{n} + {T}_{l}^{n} ) \vert\end{matrix} \qquad ( 4 )$$

Where fᵢ, fⱼ, fₖ, fₗ is the assign time for the vehicle generated by AIM system. e^{|I}^{ᵢ}^{ⁿ}^{-P}^{ᵢ}^{|} is the conditional check on the vehicle to follow the intersection SPaT information. If

$${T}_{i}^{n} = {T}_{j}^{n} or {T}_{i}^{n} = {T}_{k}^{n} or {T}_{i}^{n} = {T}_{l}^{n} or {T}_{i}^{n} = {T}_{i}^{( n + 1 )}$$

the ego vehicle will collide with any of the four vehicles. Ego CAV velocity is one control variable to avoid collision and following path. (4) contains all the parameters that are received by another vehicle in V2V communication. However, this cost function has an upper and lower bound to prevent unwanted delay and excessive speed while CAVs operate at the intersection. (5) shows the formulation of upper and lower bound constraints.

$$\{ \frac{{D}_{min}}{{V}_{max}} \leq {ζ}_{i}^{n} \leq \frac{{D}_{max}}{{V}_{min}} \qquad ( 5 )$$

Where Dₘᵢₙ=1 m and Dₘₐₓ=7 m is the separation distance and Vₘᵢₙ and Vₘₐₓ is the upper and lower limit of ego velocity.

In the study, the cooperative navigation, guidance, and control strategy of an example implementation of the present disclosure was implemented on a simulated Ego Vehicle using a MATLAB/Simulink environment. Five vehicles simulated one actor vehicle in each lane and one ego vehicle in lane ‘i’, as shown in FIG. 6. ζ is the separation time between ego vehicle and actor vehicles.

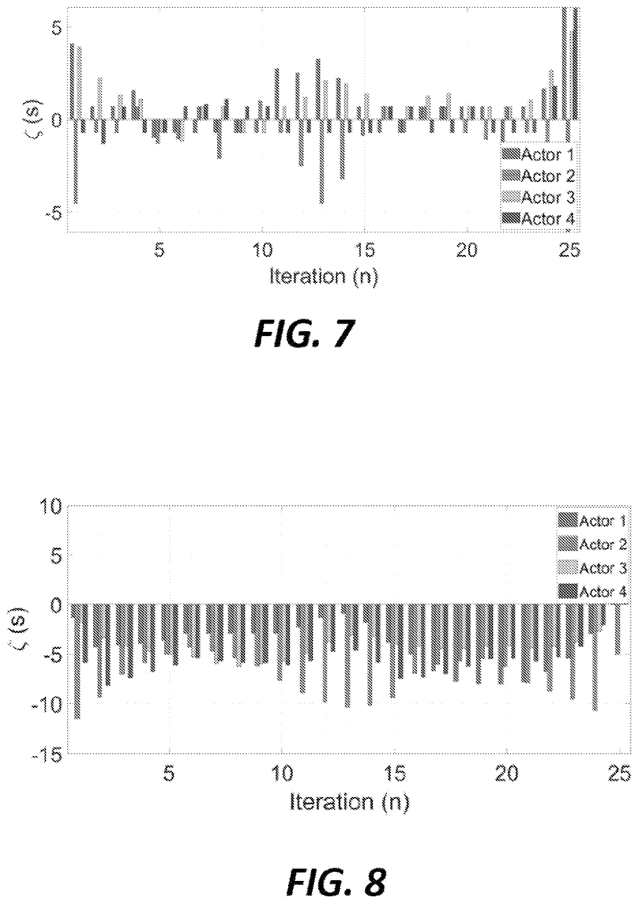

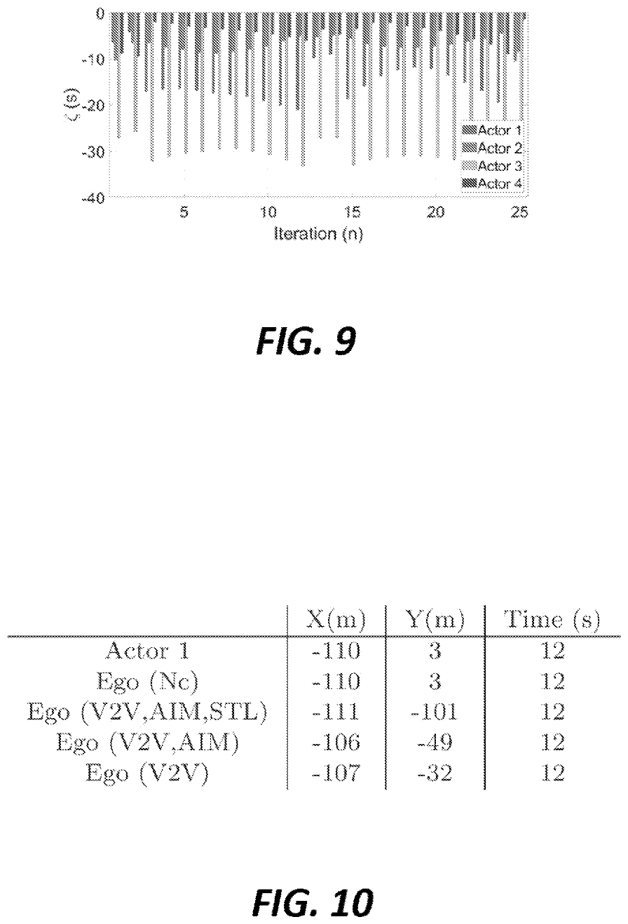

The separation time shown in FIGS. 7, 8, and 9 show different actor vehicles in a scenario. The separation times shown in FIGS. 7, 8, and 9 are relative to the ego vehicle, so the ego vehicle is not shown in FIGS. 7-9. FIG. 7 shows V2V cooperation, FIG. 8 shows V2V and AIM cooperation, and FIG. 9 shows V2V, AIM, and STL cooperation. Simulation results show the effectiveness of the example implementation of an optimization and control framework by ensuring the values of the upper and lower bound constraints as defined in Eq. (5). FIG. 7 shows the plot for the cooperative collision avoidance result discussed in a scenario where only V2V cooperation is available. The vertical axis shows the separation time concerning the ego vehicle at the conflict point identified by the cooperative collision avoidance algorithm. The horizontal axis is the sample for each second during the simulation. Non-zero value of actor vehicle shows that at any instant, ego vehicle and actor vehicle do not collide based on velocity profile followed by actor vehicle and optimized velocity followed by ego vehicle. Negative value shows that the actor vehicle passes before the ego vehicle at a potential conflict point.

In FIG. 7, the interval between 10 to 18 shows that the ego vehicle crosses the conflict point much earlier than the actor vehicle. The ego vehicle tries to maintain the least possible separation distance that also ensures the increase in intersection's capacity with safety. FIG. 8 shows a cooperative collision avoidance result discussed in a scenario where V2V and AIM cooperation is available. In the simulation represented by FIG. 8, all actor vehicles pass after the ego vehicle as the time stamp provided to the ego vehicle is much earlier than the actor vehicle. FIG. 9 shows the cooperative collision avoidance result discussed in a scenario where V2V, AIM, and STL cooperation is available. More separation time between each actor vehicle and ego vehicle shows that SPaT information also provides collision avoidance to CAV.

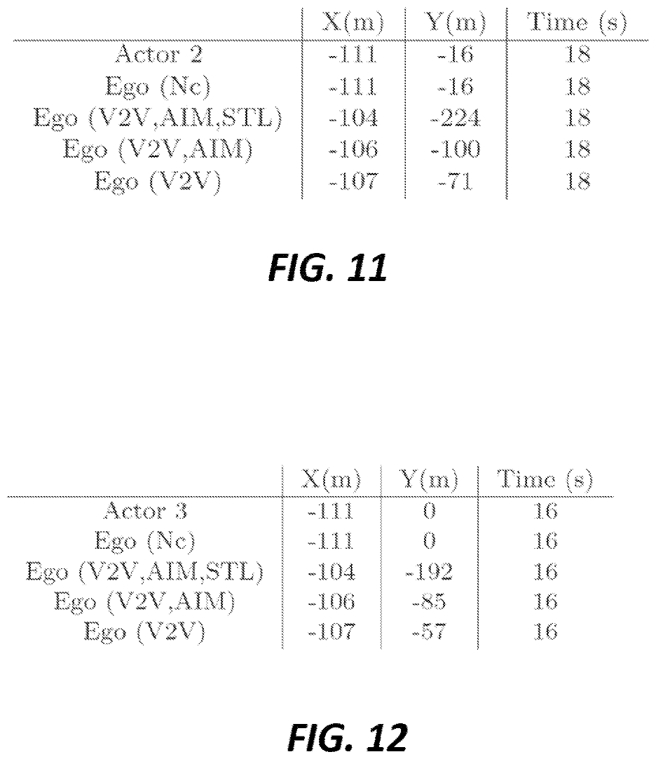

Since vehicles can enter and leave the intersection at a much faster speed, therefore, time spent by the vehicle at the intersection is less than the scenario where vehicles use V2V communication only. This in turn increases the throughput of the intersection. FIG. 10 shows the quantitative analysis for actor 1. FIG. 11 shows the quantitative analysis for actor 2, and FIG. 12 shows the quantitative analysis for actor 3. The time column in FIGS. 10, 11, and 12 show the reference time when actor vehicles collide with ego vehicles in a scenario where no cooperation is done between vehicles. The tables illustrated in FIGS. 10, 11, and 12 show the level of cooperation of the ego vehicle. In the position column, different position at the same time stamp at different cooperation level shows that the ego vehicle mange to avoid collision and move faster than when there is no cooperation. Where actors 1, 2, and 3 had conflicting situations at simulation times of 12, 18, and 16 seconds respectively. Actor 4 is in the same lane as the ego vehicle, therefore, it maintains a safe distance throughout the trajectory.

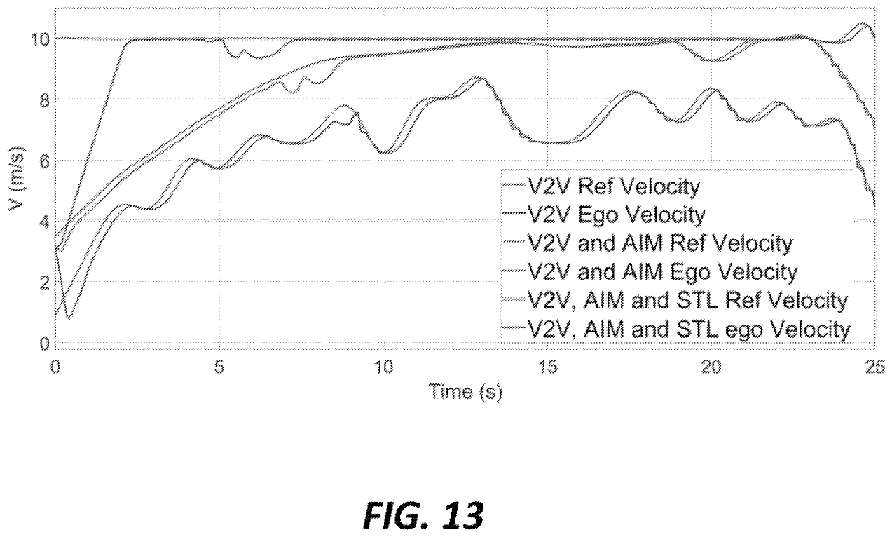

The efficacy of the path following algorithm is shown in FIG. 13. As the path following algorithm receives guidance from the cooperative collision avoidance algorithm, it starts tracking the desired velocity. FIG. 13 shows that the ego vehicle is following the reference velocity profile while crossing the intersection. Velocity tracking results show that cooperative collision avoidance algorithms provide different velocity profiles in different scenarios. Cooperative collision avoidance reference velocity provided by V2V cooperation only is the slowest velocity profile to operate safely at the intersection and avoid the collision. The reference velocity profile provided by V2V and AIM Cooperation slightly increases the velocity of the ego vehicle within the bounds of safety limits provided by AIM which gives an ego vehicle an edge to move faster than it is moving in V2V cooperation. The reference velocity is at its maximum value when all V2V, AIM, and STL cooperation is available, hence giving maximum throughput. Therefore, the example cooperative navigation, guidance, and control strategy increase the throughput with safety.

The study shows that the example implementation allows the CAV to behave intelligently and cooperate with other vehicles while passing through a smart intersection. The simulations of the example implementation of a cooperative navigation algorithm used infrastructure information with sensor feedback. The example implementation of a cooperative navigation Algorithm improved safety and intersection capacities while operating at the smart intersection. The efficacy of the example implementation was evaluated and validated by static environmental parameters, which will be extended to the dynamic environment in the future. This work can also be extended to explore the action of CAVs in presence of threats. While the example implementation was applied to an example intersection, it should be understood that the systems and methods described herein can be applied to other scenarios including CAVs having cooperative navigation technology.

### Example 2

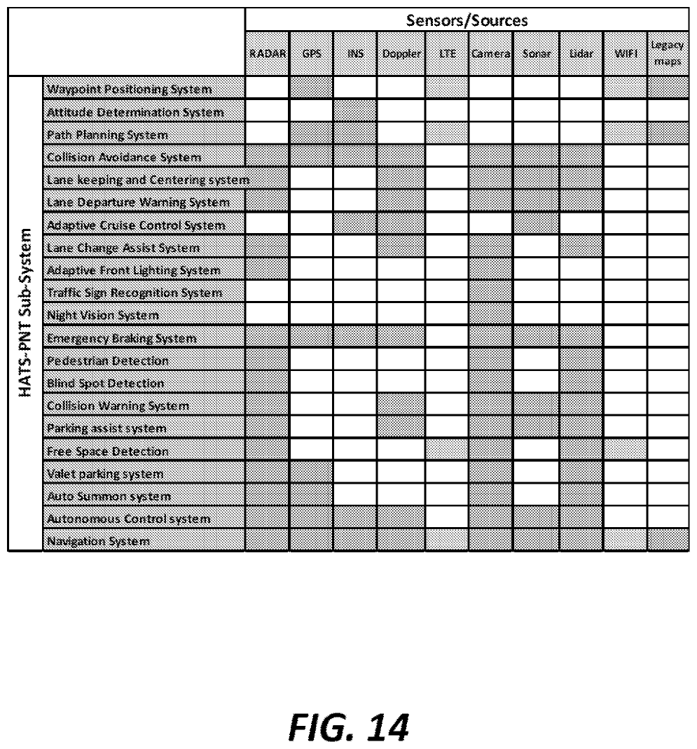

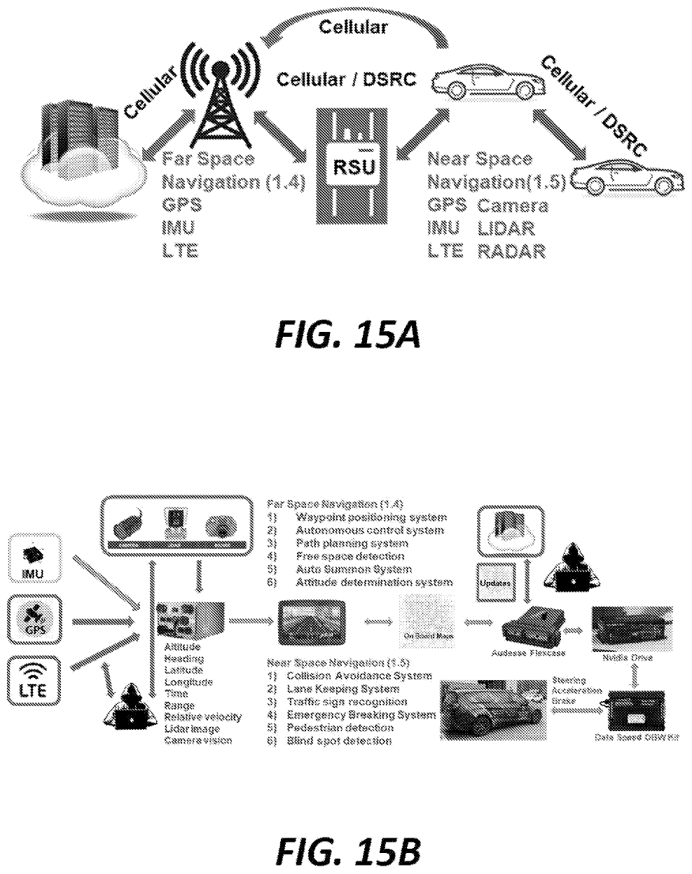

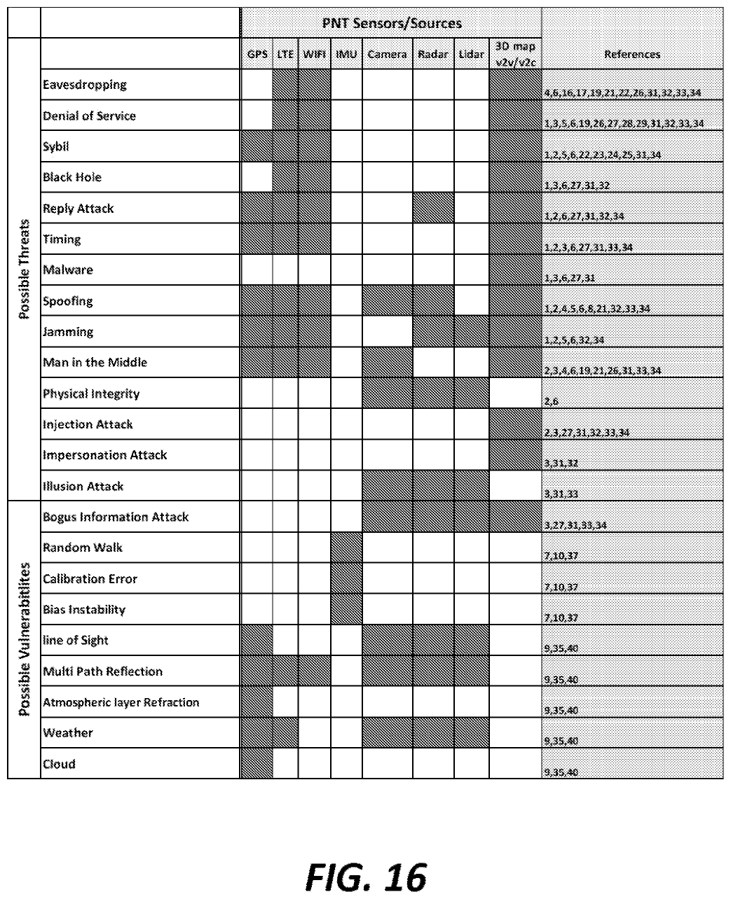

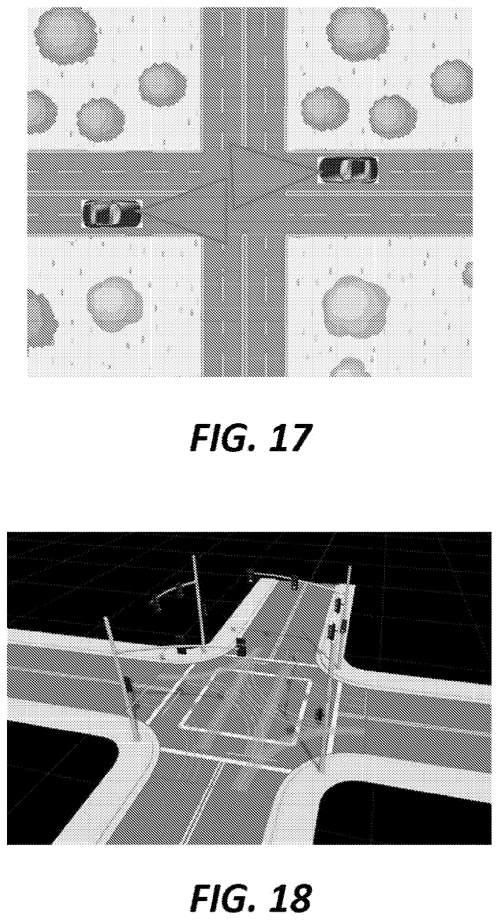

A study was performed on communications and sensing that can be implemented by the present disclosure. An example list of sensors and sources that can be used by different highly automated transportation systems (HATS) including positioning, navigation, and timing (PNT) information is illustrated in FIG. 14. FIG. 15A illustrates an example schematic of a communication system that can be used in implementations of the present disclosure. FIG. 15B illustrates examples of near space navigation and far space navigation systems, according to an implementation of the present disclosure. FIG. 16 illustrates PNT sensors and sources along with possible threats and vulnerabilities, according to implementations of the present disclosure. FIG. 17 illustrates an example of radar interference that can occur in a smart intersection, according to an implementation of the present disclosure. FIG. 18 illustrates an example of a simulated smart intersection, according to an implementation of the present disclosure.

### Example 3

Another study was performed on an example implementation of the present disclosure. The study evaluated PNT solutions in adverse cyber-security scenarios for HAVs operating at smart intersection. The example implementation can reduce conflicting situations at the smart intersection where infrastructure can experience jamming and interferences from cyber-attacks, avoid collisions and enhance safety in adverse Cyber-Security situations, and/or follow a path with optimal speed and enhance the capacity of a smart intersection

The example implementation included a scenario with 3 communication devices: Vehicle to Vehicle (V2V), Autonomous Intersection management (AIM) and Smart traffic Light (STL). FIG. 1A illustrates an example cooperative navigation system that was used for the study, and FIG. 2A illustrates an example cooperative collision avoidance algorithm that was used in the study. The study included an Objective Function for C-CAS:

$${ξ}_{i}^{n} = \vert {e}^{\vert {1}_{i} - {P}_{i} \vert} ( {f}_{i}^{n} + {T}_{i}^{n} ) - {e}^{\vert {1}_{i} - {P}_{i} \vert} ( {f}_{i}^{n + 1} + {T}_{i}^{n + 1} ) \vert$$

$${T}_{i}^{n} = \frac{{c}_{q}^{i} - {x}_{{i}_{1}}^{n}}{{x}_{{i}_{2}}^{n} cos ( {x}_{{i}_{5}}^{n} ) - {x}_{{i}_{4}}^{n} sin ( {x}_{{i}_{5}}^{n} )} + {τ}_{i}^{n}$$

Where the objective function constraints were:

$${t}_{i}^{+} + {τ}_{i}^{+} + {i}_{+}^{} \leq {t}_{j}^{-}$$

$$\frac{( {c}_{n}^{-} ( i ) - {c}_{n}^{+} ( i ) )}{{v}_{max}} \leq {t}_{i}^{+} + {τ}_{i}^{+} + {i}_{+}^{} \leq \frac{( {c}_{n}^{-} ( i ) - {c}_{n}^{+} ( i ) )}{{v}_{min}}$$

$$\frac{{L}_{i}}{{v}_{max}} \leq {τ}_{i}^{+} \leq \frac{{L}_{i}}{{v}_{min}}$$

$$\frac{{w}_{i}}{{v}_{max}} \leq {i}_{+}^{} \leq \frac{{w}_{i}}{{v}_{min}}$$

Where cₙ⁻(i) is the any conflict point for vehicle “i” enters and cₙ⁺ (i) is the same conflict point vehicle leaves.

The study included a dynamic model of CAVs: SAE-J670e

$$Longitudinal velocity : {\dot{x}}_{{i}_{1}}^{n} = {x}_{{i}_{2}}^{n} cos ( {x}_{{i}_{5}}^{n} ) - {x}_{{i}_{4}}^{n} sin ( {x}_{{i}_{5}}^{n} )$$

$$Longitudinal acceleration : {\dot{x}}_{{i}_{2}}^{n} = \frac{{P}_{{i}_{f}}^{n} + {P}_{{i}_{r}}^{n} - {F}_{{i}_{↑ f}}^{n}}{m} - {x}_{{i}_{r}}^{n} {x}_{{i}_{6}}^{n}$$

$$Lateral velocity : {\dot{x}}_{{i}_{3}}^{n} = {x}_{{i}_{4}}^{n} cos ( {x}_{{i}_{5}}^{n} ) - {x}_{{i}_{2}}^{n} sin ( {x}_{{i}_{5}}^{n} )$$

$$Lateral acceleration : {\dot{x}}_{{i}_{4}}^{n} = \frac{{P}_{{i}_{f}}^{n} {δ}_{i}^{n} + {F}_{{i}_{↑ f}}^{n} + {F}_{{i}_{↑ r}}^{n}}{m} - {x}_{{i}_{2}}^{n} {x}_{{i}_{6}}^{n}$$

$$Heading rate : {\dot{x}}_{{i}_{5}}^{n} = {x}_{{i}_{6}}^{n}$$

$$Heading angular acceleration : {\dot{x}}_{{i}_{6}}^{n} = \frac{{aP}_{{i}_{f}}^{n} {δ}_{i}^{n} + {bF}_{{i}_{↑ f}}^{n} + {bF}_{{i}_{↑ r}}^{n}}{I}$$

The states used in the example objective function were: longitudinal velocity, lateral velocity, and heading rate. The example collision avoidance algorithm found solutions of defined conflict points for the ego vehicle. The example objective function ensured the time separation between ego vehicle and other vehicle by adjusting the ego vehicle speed.

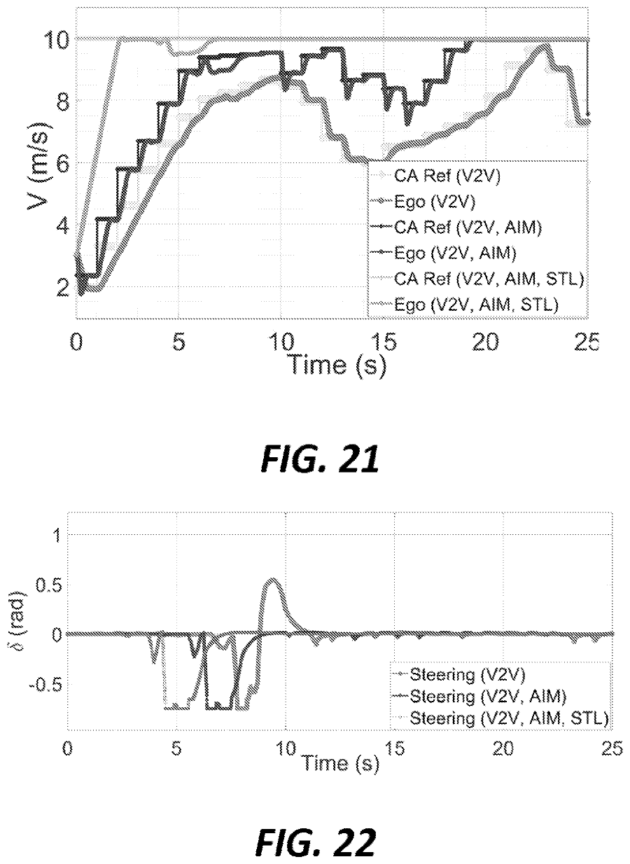

The capacity of the intersection is ensured by the increased in velocity while crossing intersection as the level of cooperation increases. FIGS. 21-24 illustrate experimental results.

FIG. 21 illustrates the velocity of different simulated vehicles as a function of time, according to an example implementation of the present disclosure.

FIG. 22 illustrates steering angles of simulated vehicles when V2V, Aim, and/or STL are used in the example implementation of the present disclosure.

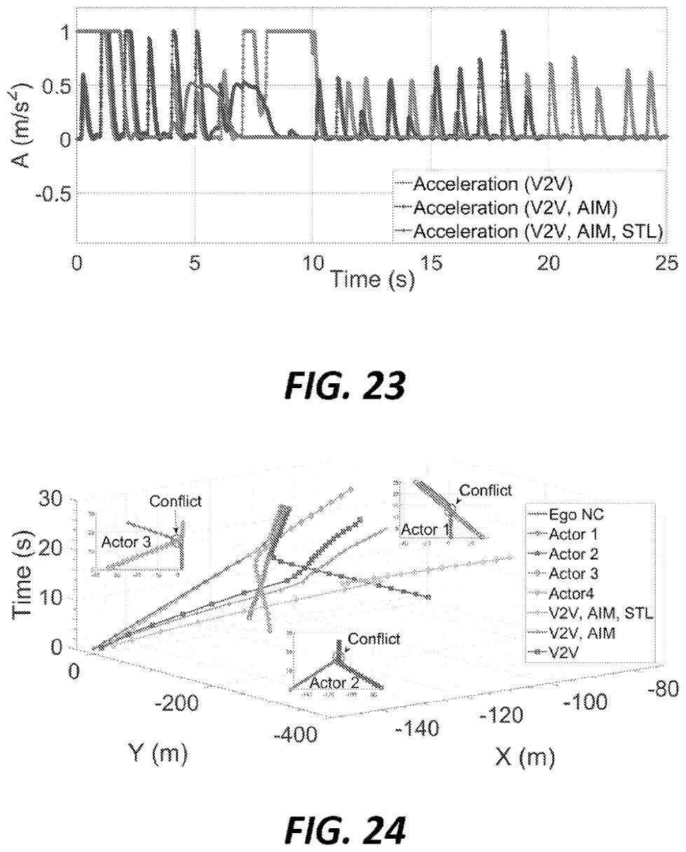

FIG. 23 illustrates acceleration when V2V, Aim, and/or STL are used in the example implementation of the present disclosure.

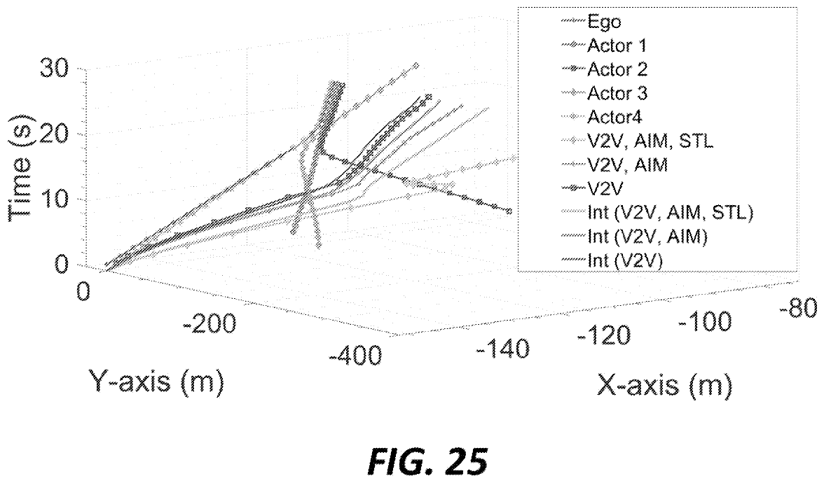

FIG. 24 illustrates 3D positioning of HAVS in jamming scenarios, according to an example implementation of the present disclosure. Implementations of the present disclosure can be configured to analyze cyber-security threat scenarios including information denial or jamming, patching information, false information or spoofing, and/or asynchronous timing. FIG. 25 illustrates another example of 3D-positioning of HAVs in jamming and interference scenarios.

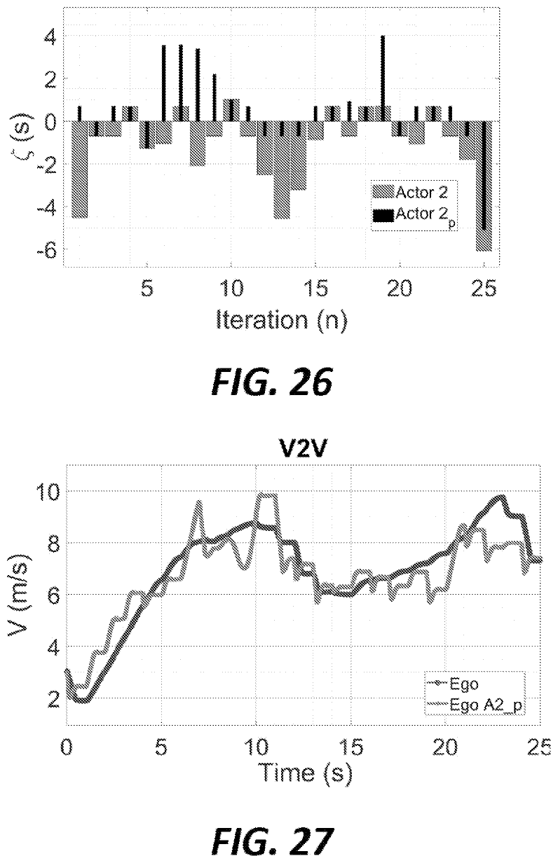

FIG. 26 illustrates additional results from the study. FIG. 26 illustrates a safety result showing that patchy information related to actor 2's velocity changes the separation time. The separation time can decrease, but the system still avoids a collision.

FIG. 27 illustrates capacity result showing that patchy information related to actor's 2 velocity also changes the CA velocity output, but the velocity profile remains the same with some chattering.

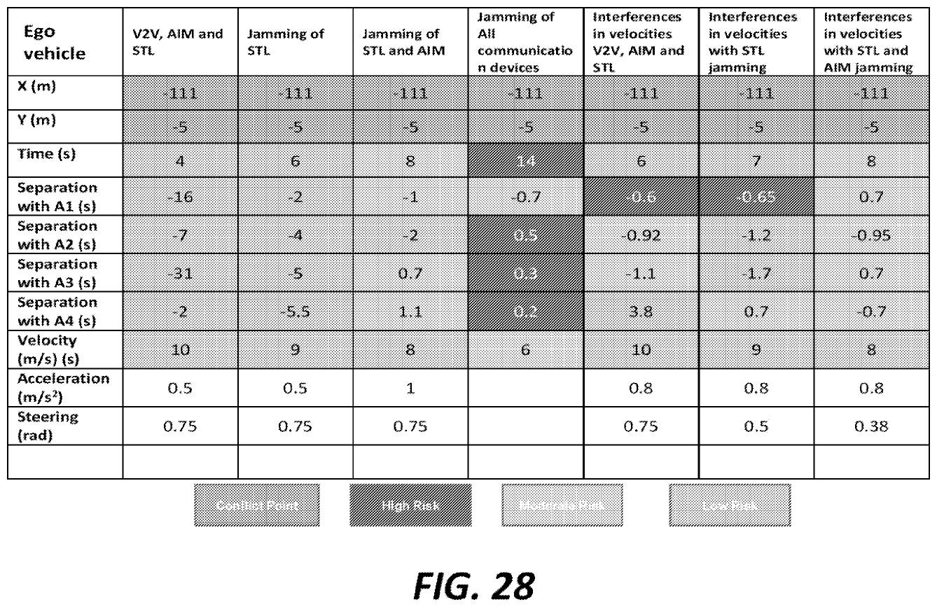

FIG. 28 illustrates a qualitative analysis of jamming and interferences, according to an example implementation of the present disclosure.

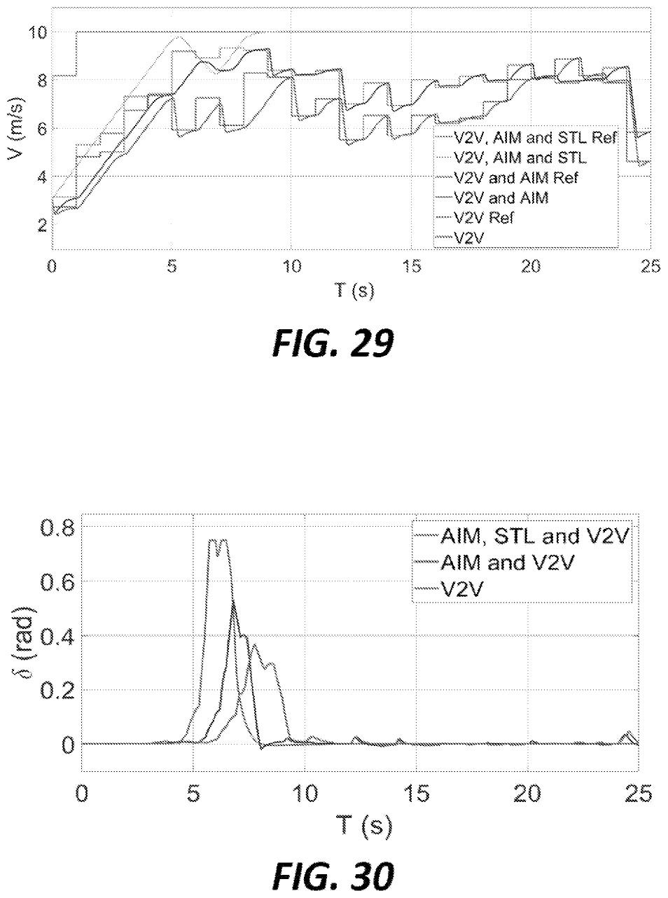

FIG. 29 illustrates a capacity result for different communication systems, where velocity is plotted as a function of time.

FIG. 30 illustrates a capacity result for different communication systems, where the steering of a vehicle is plotted as a function of time.

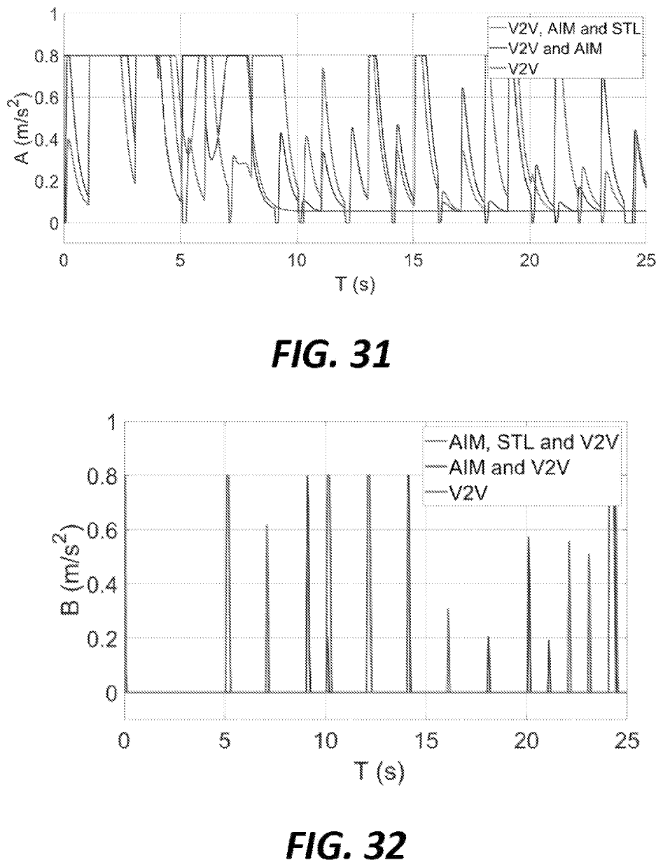

FIG. 31 illustrates a capacity result for different communications systems, where the acceleration of a vehicle is plotted as a function of time.

FIG. 32 illustrates a capacity result for different communications systems, where the acceleration of a vehicle is plotted as a function of time.

### Example 4

Another study was performed of an example implementation including a methods and systems for safety testing and validation of Highly Automated Vehicles (HAVs) by using cooperative navigation at the smart intersections. The example implementation can enhance the safety of the intersection. The purposed methodology can allow HAVs to safely navigate through intersections while operating with non-cooperative vehicles. A significant challenge of this context is that city intersections are often complex environments where onboard sensors may not be able to detect all relevant information, such as vehicles or pedestrians behind obstructions. To address this issue, the proposed approach uses beyond-visual range information from vehicles that are transmitted via an everything communication network. This allows HAVs to perceive their surroundings and make safer navigation decisions. The cooperative navigation of HAVs is achieved through the use of data from various sources, including RSU's, OBU's, AIM systems, and STL's. The example implementation includes several features, including cooperative collision avoidance (CCA), cooperative cruise control (CCC), and cooperative adaptive lane keeping (CALK). In addition, HAVs are able to follow predefined paths using model predictive control. In the example implementation each vehicle is an independent agent, makes its own decision based on the information available from the vehicle to the everything communication network, and uses a mathematical model to predict future behavior for optimized navigation solutions. The study tested the performance of the cooperative navigation framework, including with an example scenario in which HAVs operate at a smart intersection. The results shown herein show that safety can be ensured in a dynamic scenario.

Autonomous vehicles can rely on a range of technologies, including vehicle-to-vehicle (V2V) communication, vehicle-to infrastructure (V2I) communication, vehicle-to-cloud (V2C) communication, and vehicle-to-pedestrian (V2P) communication, to operate safely in an environment. In addition, guidance, navigation, and control systems are essential for ensuring the safety of HAVs and all road users [1c]. To advance the growth of autonomous systems, investment opportunities have been established by government agencies for automotive manufacturers, technology companies, and research institutes. An example is the Smart Columbus project, which seeks to turn Columbus into a shining example of a smart connected city for HAVs. This project aims to enhance the quality of life, economic prosperity, sustainability, and safety in Columbus through the integration of HAVs [2c]. Researchers and scientists are making substantial contributions to the creation of a secure and highly dependable autonomous system for smart cities. There are several navigation methodologies used in different applications. Since HAVs are able to communicate with each other and their surrounding infrastructure in order to improve their navigation and decision-making abilities.

There are several methodological frameworks for the cooperative navigation of HAVs, including:

Hierarchical Control: In this approach, a central controller coordinates the movements of multiple HAVs, taking into account the overall traffic flow and the individual objectives of each vehicle [3c]. HAVs longitudinal velocity are depends on central control system its mean that malicious actor can disturbed complete traffic flow by just interfering centralized control system.

Game-theoretic approaches: These frameworks use principles from game theory to model the interactions between HAVs and to design strategies for cooperation [4c]. It increases the computational complexity and based on assumption of others behavior which may not be reliable in vulnerable situations.

Multi-agent systems: In this approach, each HAV is modeled as an independent agent that is able to make its own decisions based on local information and communication with other HAVs [5c]. Multi-agent systems are flexible, scalable, robust, decentralized, adaptable, and facilitate collaboration among agents. These properties make them well-suited for complex tasks and allow for more efficient use of resources, adaptability to changing circumstances, and improved performance, but there is no literature that discusses its application in intersection scenarios. Distributed optimization: This approach involves designing algorithms that allow HAVs to communicate and coordinate their movements in order to optimize some global objective, such as minimizing fuel consumption or travel time [6c]. The implementation of a distributed optimization navigation system at a signalized smart intersection requires a different framework and V2X communication, as the current approach focuses on unsignalized intersections. To effectively navigate a signalized intersection, a system that incorporates V2X communication and a tailored framework can be developed.

Machine learning: Machine learning algorithms can be used to predict the behavior of other HAVs and to optimize the navigation of a HAV based on this prediction [7c]. Machine learning in HAV navigation may suffer from over-fitting and poor generalization, as well as a lack of transparency and explain-ability in decision making. Additionally, collecting and labeling the necessary data for training can be a time consuming and costly process. Decentralized control: In this approach, each HAV makes its own navigation decisions based on local information and communication with its immediate neighbors, without the need for a central controller [6c]. Decentralized navigation in HAVs has several advantages, including increased scalability, flexibility, and robustness, as well as reduced risk of a single point of failure and improved resource utilization. Additionally, decentralized navigation enables collaboration between vehicles and allows for continuous improvement through learning and adaptation.

Model-based predictive control: This approach involves using a mathematical model of the HAV's dynamics to predict its future behavior and optimize its navigation [8c]. Model predictive control (MPC) is a control strategy for HAVs navigation that can handle constraints and optimally balance multiple objectives. MPC uses a model of the system to predict its behavior over a future horizon and generates control inputs that optimize a performance criterion based on the predicted behavior.

Consensus-based approaches: These approaches involve designing algorithms that allow HAVs to reach a consensus on their navigation decisions through iterative communication and negotiation [9c]. One of the main drawbacks of a consensus-based approach in HAV navigation is that it may not be efficient in handling large amounts of data in real-time. This is because each vehicle needs to exchange information with every other vehicle in the system, which can lead to increased communication overhead and decreased performance. Additionally, the consensus process can be vulnerable to errors or attacks, which can compromise the reliability of the navigation system.

Graph-based methods: These methods involve representing the HAVs and their environment as a graph, and using graph theoretic techniques to optimize the navigation of the HAVs [10c]. The graph-based navigation system has some limitations, such as the difficulty of handling real-world scenarios with unpredictable elements, and the computational complexity of constructing and solving the graph. This can limit the efficiency and accuracy of the navigation system.

Reinforcement learning: Reinforcement learning algorithms can be used to learn optimal navigation strategies for HAVs through trial-and-error [11c]. Reinforcement learning has some limitations including difficulty in modeling complex environments, lack of interpret-ability, and the need for a large amount of data and computational resources. Additionally, it can be difficult to ensure safe and reliable behavior in real-world applications due to the trial-and-error nature of reinforcement learning.

The example implementations of the present disclosure includes methodological frameworks that combine multi-agent systems, decentralized control, and model-based predictive control framework used for HAVs navigation. In the example implementation each HAV can be an independent agent, make its own decision based on the information available from the vehicle to everything (V2X) communication network, and/or use a mathematical model of HAV to predict future behavior and optimize navigation solutions.

Implementations of the present disclosure can be immune to interference in single agent systems and requires less computational power compared to machine learning navigation frameworks. In a signalized smart intersection scenario, where only leading vehicles collaborate to cross the intersection, the consensus based approach may not be appropriate. The graphical approach and reinforcement learning require a large amount of data exchange through V2X communication channels, which is not necessary in the proposed methodology, but can pose challenges in real-time scenarios.

The study simulated results using an example intersection scenario 600, illustrated and described with reference to FIG. 6. In this study, the intersection scenario 600 was studied with HAVS. This intersection features advanced technology such as RSUs, AIM systems, and STL with short-range communication technologies (DSRC). RSUs serve as edge communication devices that transmit information about the infrastructure and receive basic safety messages (BSM) from vehicles. AIM is an intersection management system that synchronizes multiple connected intersections in an area to enhance the capacity, and safety at intersections and provide time slots for HAVs approaching an intersection to optimize fuel consumption at the smart intersection. STL is a smart traffic light system that can be controlled signal, phase, and time (SPaT) information according to the situation by the autonomous management system. The vehicles in this scenario share information about their state, such as their current position in terms of latitude and longitude, velocity, heading angle, and dimensions. The vehicles also share information about the GPS receiver location point and the status of the turn indicator. It is assumed that the vehicles' perception sensors are functioning correctly and providing accurate relative positioning and speed information about other vehicles and any surrounding obstacles. The present example considers the leading vehicles in each lane. However, it should be understood that the example implementation can be extended to other vehicles in the same lane. This allows the vehicle to have a better understanding of the situation in the smart intersection and make critical decisions accordingly.

FIG. 6 illustrates a smart intersection scenario equipped with RSU, AIM, and STL. HAVs operating at the smart intersection have OBU to communicate through V2V and V2I communication networks. FIG. 6 shows an intersection scenario with three vehicles in each lane, all moving in different directions (left turns, right turns, and straight). The lead vehicle in lane “i” is a HAV that must take the left-turn path, with the ego vehicle following behind. Meanwhile, the HAV in lane “j” must continue straight, the HAV in lane “k” must make a right turn, and the HAV in lane “l” must also make a left turn. This scenario generates two conflict points in terms of the ego vehicle's latitude and longitude positions, and three conflicting situations in the given time frame. The other vehicles are automated but do not have cooperative capabilities for beyond visual range information. The purpose of this scenario is to test the proposed cooperative navigation framework in a complex situation and evaluate its impact on the safety and efficiency of the intersection for all vehicles.

Cooperative navigation is a method that can be used by multiple autonomous agents, such as robots or drones, to navigate and accomplish tasks together. In a cooperative navigation system, the agents work together to achieve a common goal while taking into account the actions and positions of the other agents. This allows them to coordinate their actions and make efficient use of their resources, such as sensors (Radar, Camera, GPS, INS, and Lidar) or communication channels (V2V, V2I, V2P, V2C, and V2X). Cooperative navigation can be used in a variety of applications, such as search and rescue, surveillance, and exploration. In the automotive industry, it is used to enhance the safety, capacity, and fuel efficiency of HAVs especially when they are operating at the smart intersection. The proposed Methodological framework is inspired by a multi-agent system, Decentralized control, and Model predictive control. As a multi-agent system, and decentralized control provides robustness, flexibility, scalability, efficiency while MPC can handle constraints, multiple objectives, multivariable nonlinear system, and also handle the uncertainty of the system. Therefore the present disclosure includes mixed approaches including any/all of these capabilities.

The illustration in FIG. 3A presents a visual representation of an example cooperative navigation methodology applied in a system 300, including the flow and type of information exchanged between smart infrastructure and HAVs. The CCC component makes use of all relevant information from the other vehicles on the road, the ego vehicle, and environmental factors to determine an optimized velocity for the ego vehicle, enabling it to safely navigate through potentially hazardous scenarios. Optimized velocity can be shared with the path-following system 134 along with its sub-systems CCC and CALK. Cooperative cruise control can provide the adaptive velocity according to the scenario and lead vehicle, while cooperative lane-keeping provides the steering command according to the predefined path and current scenario of the ego vehicle. These signals are passed to the model predictive control system 320 and the model predictive control system 320 can predict the future of the ego HAV for the defined scenario based on HAV dynamic model and generate the optimized adaptive control signals to perform the safe operation at the smart intersection. In this framework, only the GNSS and INS are used for the positioning of the ego vehicle. All other information was shared through the V2X communication network. The initial version of this framework was published before that has the capability of a cooperative collision avoidance system and path-following system based on information coming from the V2X communication network [12].

Eq.1 describes the mathematics used in the example system and method.

$$\{ \begin{matrix}{ζ}_{i}^{n} = \vert {e}^{\vert {I}_{i}^{n} - {P}_{i} \vert} ( {f}_{i}^{n} + {T}_{i}^{n} ) - {e}^{\vert {I}_{i}^{n + 1} - {P}_{i} \vert} ( {f}_{i}^{n} + {T}_{i}^{n + 1} ) \vert \\ \frac{{D}_{min}}{{V}_{max}} \leq {ζ}_{i}^{n} \leq \frac{{D}_{max}}{{V}_{min}} \\ {V}_{ego} = {V}_{rel} + {V}_{lead} \\ {D}_{min} = {D}_{s} + {G}_{t} * {V}_{ego} \\ {θ}_{e} = {θ}_{h} - {θ}_{c}\end{matrix} \qquad ( 1 )$$

Where fᵢ is the assigned time for the vehicle generated by the AIM system. e^{|I}^{ᵢ}^{ⁿ}^{-P}^{ᵢ}^{|} is the conditional check on the vehicle to follow the intersection SPaT information. Pᵢ is the signal phase and time information of the intersection and Iᵢⁿ is the HAVs indication variable to follow the desired path (left, right, and straight). In the proposed framework, the velocity of the ego HAV is an essential control variable to avoid collisions and stay on a predetermined path. Equation (1) shows how the cost function for each vehicle is calculated, incorporating all parameters received through V2V communication. However, to avoid unnecessary delays and excessive speeds while the HAVs navigate the smart intersection, the cost function has been restricted by upper and lower bounds, as indicated by the second expression in (1). Where Dₘᵢₙ, Dₘₐₓ Cooperative adaptive cruise control received that optimized velocity profile as the output from the first and second expression based on lead vehicle velocity and another smart intersection parameter. Since there is no sensor information involved in this framework, therefore, lead vehicle velocity is received from the V2V communication network. Third expression in 1 is the Adaptive cruise control expression where V_{ego}, Vᵣₑₗ, and V_{lead} is ego vehicle velocity, relative velocity, and lead vehicle velocity respectively. fourth expression is used to maintain a safe minimum distance where D_{S} is the safe minimum spacing between lead vehicles and Gₜ is the minimum time gap between ego and the lead vehicle. The fifth expression in equation 1 is for adaptive lane-keeping where θₑ, θₕ, and θ_{c} is ego vehicle relative yaw angle, ego vehicle heading angle, and lane centerline angle respectively. the sequence of flow of information in a purposed methodology is as follows:

Step 1: Collect information from infrastructure devices. Non-limiting example infrastructure devices include AIM, RSU, and STL.

Step 2: Scan the number of lanes and the number of vehicles in each lane.

Step 3: Extract time slot

$$“ {f}_{i}^{n} ” , “ {f}_{j}^{n} ” , {f}_{k}^{n} ” , {f}_{l}^{n} ” ,$$

information for each vehicle from AIM data

Step 4: Extract SPAT information Pᵢ, Pⱼ, Pₖ, Pₗ from STL

Step 5: Extract vehicle states

$${V}_{xi}^{n} , {V}_{yi}^{n} , {δ}_{i}^{n} , {ϕ}_{i}^{n} , {a}_{i}^{n} , {b}_{i}^{n} , {x}_{i}^{n} , {y}_{i}^{n} , {I}_{i}^{n} ,$$

from OBU through V2V communication channel

Step 6: Cooperative collision avoidance algorithm uses the information to generate a collision-free optimized velocity profile.

Step 7: CCA calculates the conflict point for other actor vehicles operating at the intersection.

Step 8: if collision exist based on followed velocity profile CCA optimizes the velocity profile using the Surrogate optimization tool.

Step 9: CCA ensures the safe separation

$${ζ}_{i}^{n} , {ζ}_{j}^{n} , {ζ}_{k}^{n} , {ζ}_{l}^{n}$$

should be greater than 0.7 s.

Step 10: based on safe distance Optimized velocity profile is fed into the cooperative cruise control system.

Step 11: Cooperative cruise control generates the following velocity based on feedback from inertial sensors, lead vehicle velocity, and optimized velocity from the cooperative collision avoidance algorithm.

Step 12: The reference and lead velocity are input into an MPC system (e.g., the model predictive control system 320 shown in FIG. 3A) and, based on predictions of the near future, the MPC control can adjust the ego vehicle velocity.

Step 13: Simultaneously, the cooperative lane-keeping algorithm received information from infrastructure devices and generated a heading angle ‘θₕ’ and lane curvature angle ‘θ_{c}’ to follow and maintain the lane center.

Step 14: Cooperative lane-keeping algorithm gets the feedback from the inertial sensor and feeds the steering angle to the MPC system.

Where

$${f}_{i}^{n} {f}_{j}^{n} {f}_{k}^{n} {f}_{l}^{n}$$

is the time slot of n^{th} vehicle in lane i, j, k, and l respectively provided by AIM to manage the capacity and safety of the intersection. Pᵢ, Pⱼ, Pₖ, Pₗ is the smart traffic signal phase information for each lane i, j, k, and l respectively according to the simulation reference time frame.

$${V}_{xi}^{n} , {V}_{yi}^{n} , {δ}_{i}^{n} , {ϕ}_{i}^{n} , {a}_{i}^{n} , {b}_{i}^{n} , {x}_{i}^{n} , {y}_{i}^{n} , {I}_{i}^{n}$$

is the longitudinal velocity, lateral velocity, steering angle, heading angle, front tire distance from the center of gravity (CG), rear tire distance from CG, longitudinal position coordinate and lateral position coordinate and turn indicator respectively for n^{th} vehicle in lane i.

$${ζ}_{i}^{n} , {ζ}_{j}^{n} , {ζ}_{k}^{n} , {ζ}_{l}^{n}$$

is the separation between ego and n^{th} actor vehicles in lane i, j, k, and l respectively.

The example implementation includes a mathematical framework for performing cooperative navigation. In Eq. 1A, the objective function defines in terms of the time of arrival, traveling time, and phase time of the signal. In (1A)

$$“ {T}_{i}^{n} ”$$

is the time vehicle takes to travel from its current position to the next waypoint.

$$\{ \begin{matrix}{T}_{i}^{n} = \frac{{C}_{q}^{i} - {x}_{i 1}^{n}}{{V}_{i}^{n}} + {τ}_{i}^{n} \\ {T}_{j}^{n} = \frac{{C}_{q}^{j} - {x}_{j {1}^{n}}}{{x}_{j {2}^{n}}} + {τ}_{j}^{n} \\ {T}_{k}^{n} = \frac{{C}_{q}^{k} - {x}_{k {1}^{n}}}{{x}_{k {2}^{n}}} + {τ}_{k}^{n} \\ {T}_{l}^{n} = \frac{{C}_{q}^{l} - {x}_{l {1}^{n}}}{{x}_{l {2}^{n}}} + {τ}_{l}^{n}\end{matrix} \qquad ( 1 A )$$

Where

$${x}_{i}^{n} , {V}_{i}^{n} , {τ}_{i}^{n} {C}_{q}^{i}$$

represent the current position, velocity, minimal separation time, and conflict point of CAV respectively. τᵢⁿ is also the function of vehicle parameters as a vehicle having a larger size in length needs more separation time than a shorter vehicle. So the conflict situation arises when

$${C}_{q}^{i} = {C}_{q}^{j}$$

at any particular timestamp. Let ζ be the difference in time of arrival from the ego vehicle to another vehicle at the intersection. Therefore, the objective function in Eq. (2) is used to minimize the ζ for all the vehicles at the intersection by using information from AIM, RSU, and OBUs.

$$\{ \begin{matrix}{ζ}_{i}^{n} = \vert {e}^{\vert {I}_{i}^{n} - {P}_{i} \vert} ( {f}_{i}^{n} + {T}_{i}^{n} ) - {e}^{\vert {I}_{i}^{n + 1} - {P}_{i} \vert} ( {f}_{i}^{n + 1} + {T}_{i}^{n + 1} ) \vert \\ {ζ}_{j}^{n} = \vert {e}^{\vert {I}_{i}^{n} - {P}_{i} \vert} ( {f}_{i}^{n} + {T}_{i}^{n} ) - {e}^{\vert {I}_{j}^{n} - {P}_{j} \vert} ( {f}_{j}^{n} + {T}_{j}^{n} ) \vert \\ {ζ}_{k}^{n} = \vert {e}^{\vert {I}_{i}^{n} - {P}_{i} \vert} ( {f}_{i}^{n} + {T}_{i}^{n} ) - {e}^{\vert {I}_{k}^{n} - {P}_{k} \vert} ( {f}_{k}^{n} + {T}_{k}^{n} ) \vert \\ {ζ}_{l}^{n} = \vert {e}^{\vert {I}_{i}^{n} - {P}_{i} \vert} ( {f}_{i}^{n} + {T}_{i}^{n} ) - {e}^{\vert {I}_{l}^{n} - {P}_{l} \vert} ( {f}_{l}^{n} + {T}_{l}^{n} ) \vert\end{matrix} \qquad ( 2 )$$

Where fᵢ, fⱼ, fₖ, fₗ is the assigned time for the vehicle generated by the AIM system.

$${e}^{\vert {I}_{i}^{n} - {P}_{i} \vert}$$

is the conditional check on the vehicle to follow the intersection SPaT information. If

$${T}_{i}^{n} = {T}_{j}^{n} or {T}_{i}^{n} = {T}_{k}^{n} or {T}_{i}^{n} = {T}_{l}^{n} or {T}_{i}^{n} = {T}_{i}^{( n + 1 )}$$

the ego vehicle will collide with any of the four vehicles. Ego CAV velocity is one control variable to avoid collision and following path. (2) contains all the parameters that are received by another vehicle in V2V communication. However, this cost function has an upper and lower bound to prevent unwanted delay and excessive speed while CAVs operate at the intersection. (3) shows the formulation of upper and lower bound constraints.

$$\{ \frac{{D}_{min}}{{V}_{max}} \leq {ζ}_{i}^{n} \leq \frac{{D}_{max}}{{V}_{min}} \qquad ( 3 )$$

Where Dₘᵢₙ=1 m and Dₘₐₓ=7 m is the separation distance and Vₘᵢₙ and Vₘₐₓ is the upper and lower limit of ego velocity.

$$\{ \begin{matrix}{V}_{ego} = {V}_{rel} + {V}_{lead} \\ {D}_{min} = {D}_{s} + {G}_{t} * {V}_{ego} \\ {θ}_{e} = {θ}_{h} - {θ}_{c}\end{matrix} \qquad ( 4 )$$

Cooperative cruise control received that optimized velocity profile as the output from CCA using 1A and 2 and based on the constraint in 3. Since there is no sensor information involved in this example framework, therefore, lead vehicle velocity is received from the V2V communication network. The first expression in 4 is for CCC where V_{ego}, Vᵣₑₗ, and V_{lead} is ego vehicle velocity, relative velocity, and lead vehicle velocity respectively. the second expression is the constraint on CCC to maintain a safe minimum distance where Dₛ is the safe minimum spacing between lead vehicles and Gₜ is the minimum time gap between ego and the lead vehicle. The output of these expressions provides CCC velocity to operate safely at the intersection. The third expression in 4 is for adaptive lane-keeping where θₑ, θₕ, and θ_{c}, is ego vehicle relative yaw angle, ego vehicle heading angle, and lane centerline angle respectively.

Collision avoidance includes solutions for unsignalized intersections [15C], [16C], and [17C]. However, implementations for signalized intersections can benefit from cooperative scenarios and systems and methods enabling cooperative control of vehicles at signalized intersections. The example implementation includes a collision avoidance algorithm that is integrated into the onboard computing system of the HAVs. The example implementation can take advantage of modern technologies such as AIM, RSU, and STL, which are available at smart intersections, to access information and make decisions. If two vehicles in a simulation have the same 3D position of [latitude, longitude, time], a collision can occur. The CCA system can calculate the desired velocity to avoid conflicts and shares the optimized velocity with the path following algorithm. The process can be repeated throughout the simulation, generating a velocity profile for the vehicle to follow as it traverses the intersection. The use of surrogate optimization meets the two key requirements for real-time optimization in automotive applications: it is computationally efficient and able to find optimal solutions quickly. In the proposed framework, optimizing the velocity of the ego vehicle requires standard information such as SPaT information from the STL, the position Pᵢ, and turn indication

$${I}_{i}^{n}$$

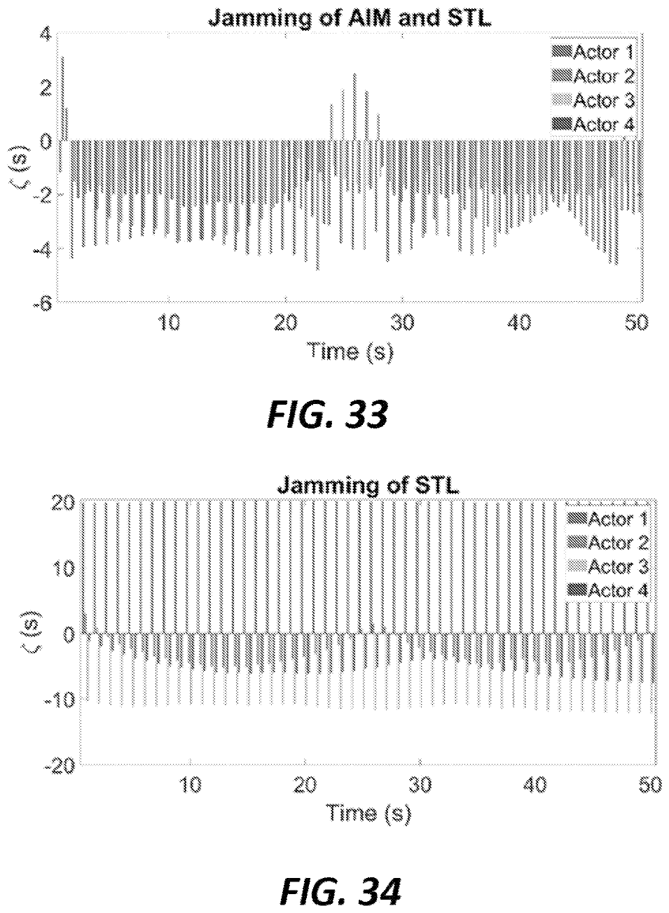

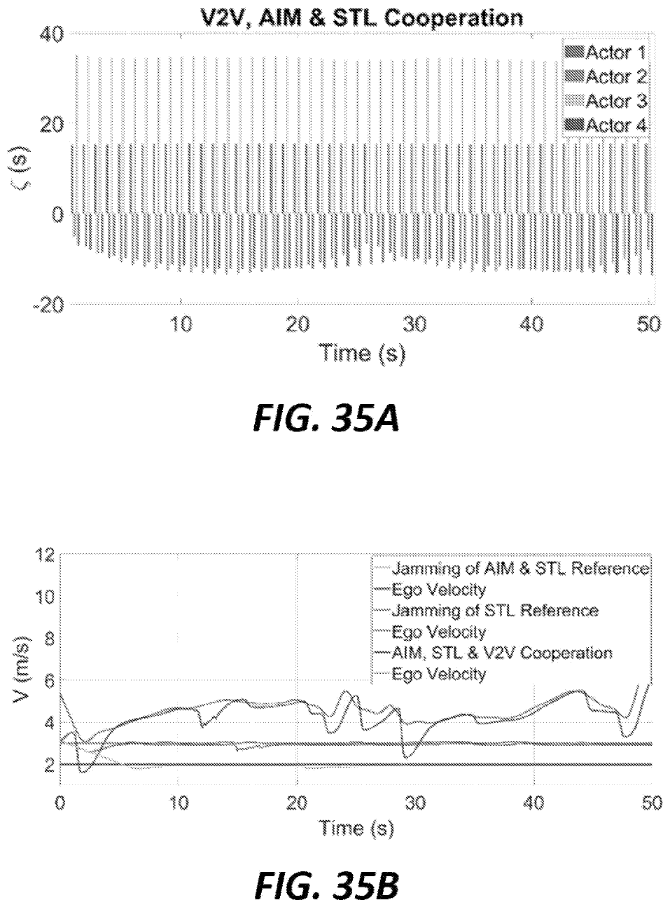

of the vehicle. The surrogate optimization process involves finding the best solution within a defined range based on the scenario. This can be achieved by using a radial basis function (RBF) interpolator to interpolate the objective function [18C]. RBF interpolation is a suitable choice for constructing the surrogate because it is computationally efficient, which is an important consideration for an automotive system. [14C]The results of the cooperative navigation in scenarios with jammed AIM and STL are shown in FIG. 33. The figure represents the separation time on the vertical axis and simulation time on the horizontal axis. In the scenario, Actor 4 is the lead vehicle, and the cooperative navigation framework uses information from the V2V communication channel to optimize the ego vehicle velocity. FIG. 34 shows the results of a scenario where STL is jammed, and FIG. 35A shows the results of a scenario where all communication is active.

CCC is a system that allows vehicles to communicate with each other and with the infrastructure to improve traffic flow and reduce fuel consumption. It can use combinations of radar, cameras, and V2V communication to sense the distance and speed of other vehicles, and to adjust the speed of the vehicle in real-time to maintain a safe following distance. The system can also be integrated with traffic lights, road signs, and other infrastructure to optimize traffic flow and reduce congestion. Additionally, CCC can also be used to improve safety by providing advanced warning of potential collisions and supporting automated emergency braking. In the example implementation, there is only V2X communication to share velocities and the relative distance of other HAVs operating at the smart intersection.

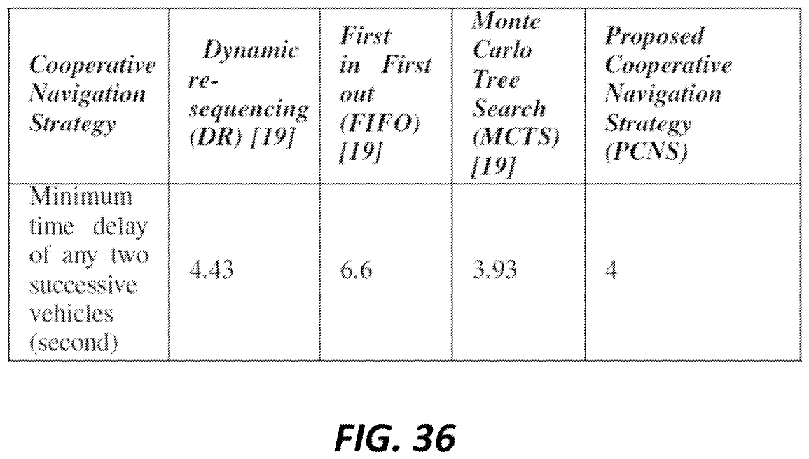

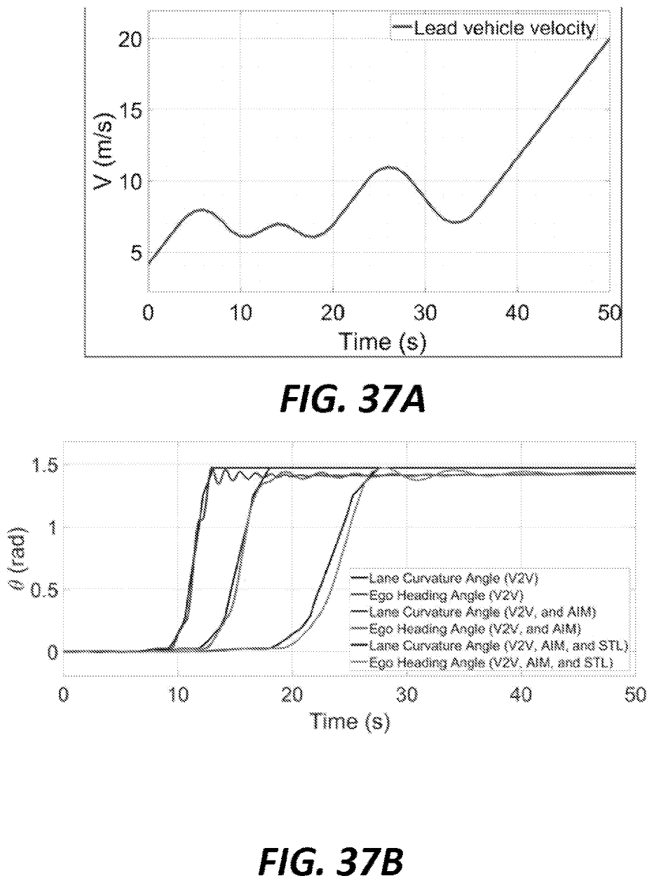

The present study included evaluations of three different threat scenarios. FIG. 35B shows that there are some frequent variations in the ego vehicle velocity and the optimized velocity from cooperative collision avoidance. FIG. 37A shows the lead vehicle velocity. Since the lead vehicle is connected with the ego vehicle but does not have the capability of cooperative navigation. Therefore, its velocity profile remains the same in the different threat scenarios. In the study's analysis, it was determined that the ego vehicle must adhere to the optimized velocity determined by the cooperative collision avoidance algorithm. This means that the cooperative adaptive cruise control must be adjusted accordingly to comply with the reference velocity established by the cooperative collision avoidance system. Under all of the specified threat scenarios, the ego vehicle is able to maintain a safe distance from the lead vehicle and avoid collisions with other vehicles at the intersection. As shown in FIG. 37B, there is a significant difference in the reference velocity from the cooperative collision avoidance algorithm and the velocity of the lead vehicle, which is traveling faster than the ego vehicle. This results in a large separation distance between the two vehicles. The example implementation permits the ego vehicle to follow the reference set by the cooperative collision avoidance algorithm, as shown in FIG. 35B. FIG. 36 illustrates the minimum delay between successive vehicles in different implementations of the present disclosure.

Implementations of the present disclosure include a Cooperative adaptive lane-keeping system (“CALK”). The CALK system is a subsystem of Cooperative Autonomous Driving System (CADS) that uses a combination of sensors, cameras, and V2V communication to improve the lane keeping and lane change capabilities of a vehicle. It provides the driver with an additional level of support by detecting the position of the vehicle relative to the road markings, and by providing steering or braking assistance to help keep the vehicle in the correct lane. The system is also able to communicate with other vehicles on the road in order to coordinate lane changes and provide advanced warnings of potential collisions. The main objective of the CALK system is to increase the safety of the vehicle and its driver by reducing the risk of lane departure accidents and collisions caused by human error.

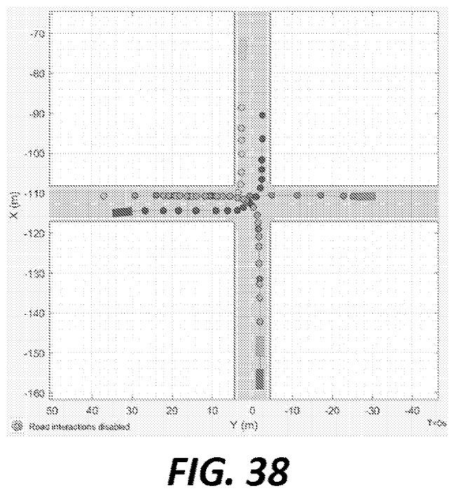

The results of three different threat scenarios using the proposed framework are shown in FIG. 37B. FIG. 37B illustrates the predefined curvature of the lane received by the ego vehicle from the RSU. The RSU has detailed information about each lane at the intersection, including the turn curvatures, which helps enhance the safety of the intersection. In the threat scenario where both AIM and STL communications are jammed, and the vehicles are limited to V2V communication, the ego vehicle crosses the intersection at a faster speed as depicted in FIG. 37B. The ego vehicle crosses the intersection from 9 sec to 12 sec in this scenario. In the scenario where only STL communication is jammed, the ego vehicle crosses the intersection from 13 sec to 17 sec, as depicted by FIG. 38. FIG. 38 illustrates the angle of the ego vehicle and lane curvature when different communication channels are active. As shown in FIG. 37B, in the example implementation the ego vehicle takes longer to cross the intersection when all communication channels are active.

The example implementation addresses the cooperative navigation of HAVs in smart intersections. It features four example components: cooperative collision avoidance, cooperative cruise control, cooperative lane-keeping, and path following. In the example implementation, each vehicle can act as an independent agent, making decisions based on V2X communication and utilizing an adaptive model predictive control to predict the near future. Results from the example threat scenarios show that the ego vehicle is able to maintain a safe distance in all cases, demonstrating the efficacy of the proposed methodology for cooperative navigation at smart intersections. The example implementation can enhance the safety and capacity of smart intersections.

### Example 5

Yet another study was performed on an example implementation of the present disclosure. The example implementation included a simulation with the following parameters: 32 conflict points; 4 vehicles operating at the intersection; each vehicle in a different lane; all vehicles are lead vehicles; Roadside units (RSU); Autonomous intersection management (AIM) system; Smart traffic lights (STL); GNSS (Position, velocity, and timing solution); Based on scenarios there are 2 potential conflict points; Only Ego vehicles use a cooperative navigation algorithm.

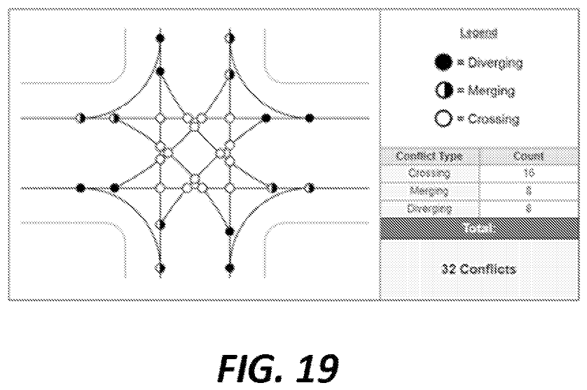

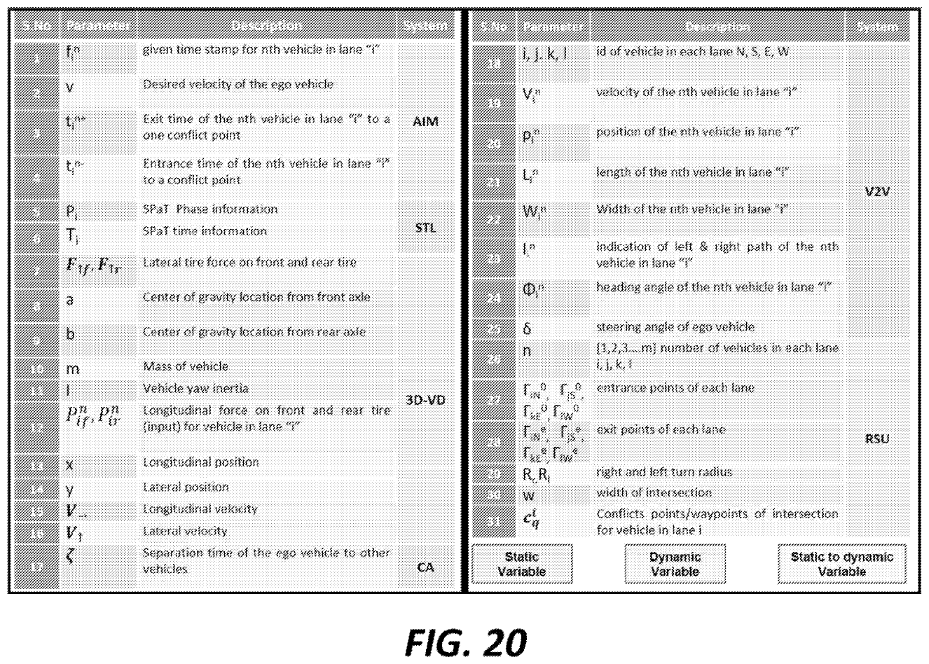

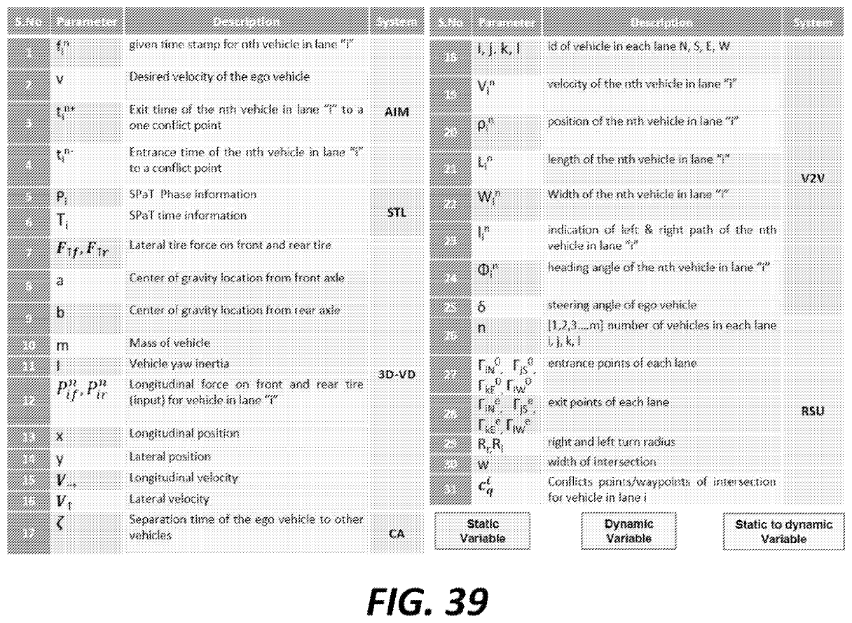

An example graph showing the four vehicle paths is illustrated in FIG. 39. Another example intersection showing conflicts is illustrated in FIG. 19. FIG. 20 illustrates a table of static and dynamic variables that can be simulated, according to implementations of the present disclosure.

The example implementation can include the system 300 shown and described with reference to FIG. 3A. The system 300 can include cooperative collision avoidance, cooperative path following, cooperative adaptive cruise control, and cooperative lane keeping.

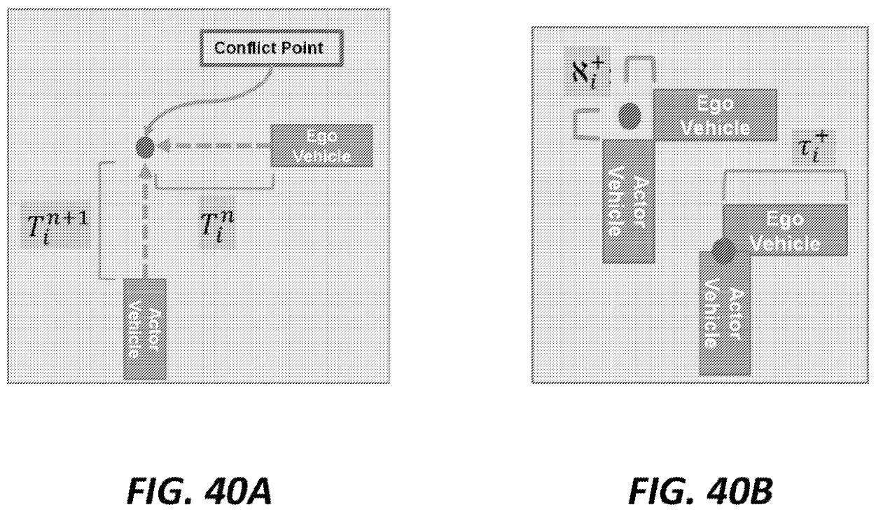

FIG. 40A and FIG. 40B illustrate schematics of vehicles at different [symbol] separations. As described herein, [symbol] is the time separation depends on the vehicles width and its velocity τ is the time separation depends on the vehicle length and its velocity AND ζ is the separation time that depends on the time ego and actor vehicles take to arrive at the particular conflict point.

The objective function for C-CAS used in the example implementation is:

$${ζ}_{i}^{n} = \vert {e}^{\vert {l}_{i} - {P}_{i} \vert} ( {f}_{i}^{n} + {T}_{i}^{n} ) - {e}^{\vert {l}_{i} - {P}_{i} \vert} ( {f}_{i}^{n + 1} + {T}_{i}^{n + 1} ) \vert$$

$${T}_{i}^{n} = \frac{{c}_{q}^{i} - {x}_{i}^{n}}{{x}_{i 2}^{n} cos ( {x}_{{i}_{5}}^{n} ) - {x}_{{i}_{4}}^{n} sin ( {x}_{{i}_{5}}^{n} )} + {τ}_{i}^{n} + {i}_{+}^{}$$

The objective function for the example study included the following objective function constraints:

$${t}_{i}^{+} + {τ}_{i}^{+} + {κ}_{i}^{+} \leq {t}_{j}^{-}$$

$$\frac{( {c}_{n}^{- ( i )} - {c}_{n}^{+} ( i ) )}{{v}_{max}} \leq {t}_{i}^{+} + {τ}_{i}^{+} + {i}_{+}^{} \leq \frac{( {c}_{n}^{-} ( i ) - {c}_{n}^{+} ( i ) )}{{v}_{min}}$$

$$\frac{{L}_{i}}{{v}_{max}} \leq {τ}_{i}^{+} \leq \frac{{L}_{i}}{{v}_{min}}$$

$$\frac{{w}_{j}}{{v}_{max}} \leq {κ}_{i}^{+} \leq \frac{{w}_{j}}{{v}_{min}}$$

Where

$${c}_{n}^{-} ( i )$$

is the any conflict point for vehicle “i” enters and

$${c}_{n}^{+} ( i )$$

is the same conflict point vehicle leaves.

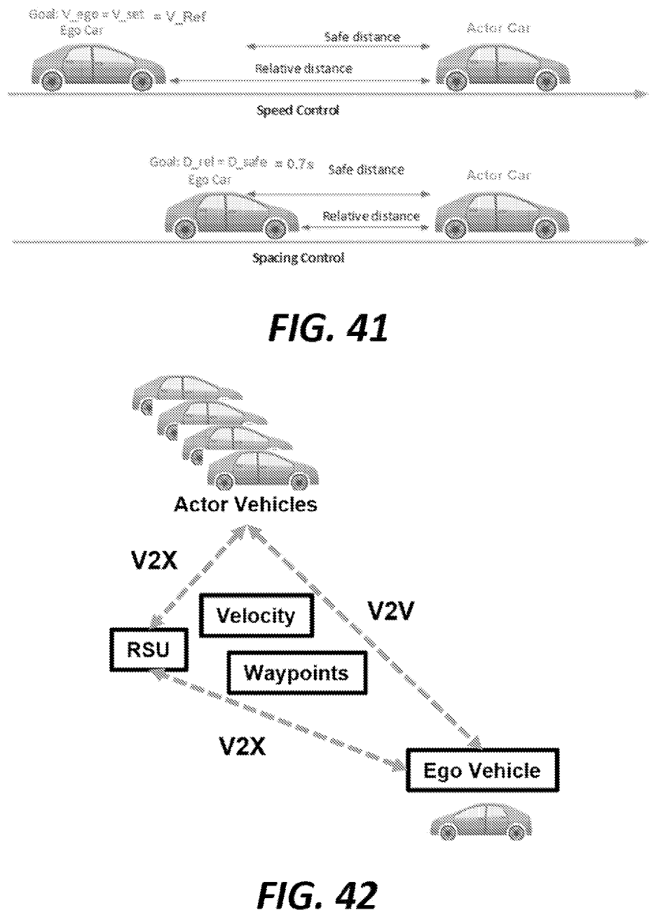

FIG. 41 illustrates example following distances including spacing and speed control. As an example, a safe separation distance at 25 mph may be 2 seconds, a safe separation distance at 45 mph may be 3 seconds, and a safe separation distance at 65 mph may be 4 seconds. Stopping distance can be considered the sum of perception time distance, reaction time distance, and breaking time distance.

FIG. 42 illustrates an example relationship between an ego vehicle and any number of actor vehicles operating in an example system.

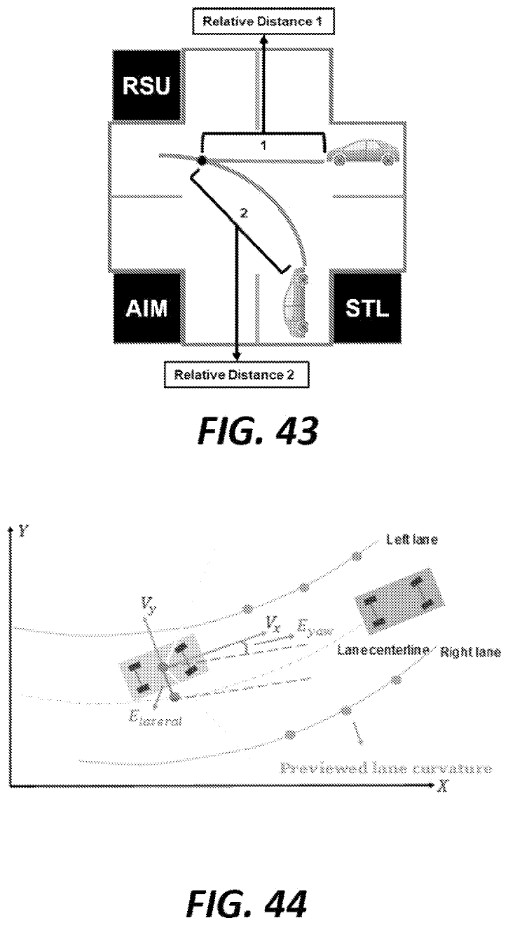

FIG. 43 illustrates an example intersection with an RSU, AIM, and STL.

FIG. 44 illustrates a schematic of a lane-keeping plant model that can be used by an MPC, according to an example implementation of the present disclosure.

Lane keeping plant model used by MPC:

$${A}_{2} = [ \begin{matrix}- 2 ( {C}_{F} + {C}_{R} ) / m / {V}_{X} & - {V}_{X} - 2 ( {C}_{F} {L}_{F} - {C}_{R} {L}_{R} ) / m / {V}_{X} \\ - 2 ( {C}_{F} {L}_{F} - {C}_{R} {L}_{R} ) / {I}_{Z} / {V}_{X} & - 2 ( {C}_{F} {L}_{F}^{2} + {C}_{R} {L}_{R}^{2} ) / {I}_{Z} / {V}_{X}\end{matrix} ]$$

$${B}_{2} = 2 {C}_{F} [ \begin{matrix}1 / m \\ {L}_{F} / {I}_{Z}\end{matrix} ]$$

$${C}_{2} = [ \begin{matrix}1 & 0 \\ 0 & 1\end{matrix} ]$$

$${D}_{2} = [ \begin{matrix}0 \\ 0\end{matrix} ]$$

Vₓ is longitudinal velocity
C_{F}, C_{R} is cornering stiffness of front and rear tiers
L_{F}, L_{R} is position of center of gravity from front and rear tires
I_{z} is yaw moment of inertia
m is total mass of vehicle

The study included a model of predictive control. The example model of predictive control included a MIMO System; Input output interactions; Constraints; Preview capabilities (look ahead); solving online optimization at defined time steps; and MPC using a Quadratic programming solver for an optimal solution.

The example MPC cost function for Cooperative Adaptive cruise control and cooperative lane keeping control includes:

$${J}_{( {z}_{k} )} = {J}_{y ( {z}_{k} )} + {J}_{u ( {z}_{k} )} + {J}_{Δ u ( {z}_{k} )} + {J}_{ε ( {z}_{k} )}$$

J_{y(z}_{ₖ}₎ is output reference tracking
J_{u(z}_{ₖ}₎ is manipulated variable tracking
J_{Δu(z}_{ₖ}₎ is Manipulated Variable Move Suppression
J_{ε(z}_{ₖ}₎ is constraints violation
zₖ is quadratic programing decision

The example implementation can include a quadratic problem solver. The quadratic problem solver can include an Interior point convex quadratic programming algorithm that can optionally include the following steps:

Pre-solve/Post-solve: The algorithm can simplify the problem by removing redundancies and simplifying constraints.

Generate Initial Point: Initializing x₀.

Predictor-Corrector: The algorithms begin by turning the linear inequalities Ax<=b into inequalities of the form Ax>=b by multiplying A and b by −1.

Stopping Conditions: The predictor-corrector algorithm iterates until it reaches a point that is feasible.

Infeasibility Detection: The merit function is a measure of feasibility. quadprog stops if the merit function grows too large.

In some implementations of the present disclosure, MPC can be tuned. Tuning MPC can include tuning any/all of the following parameters:

Sampling Time (Smaller the value will increase the computational burden).

Prediction Horizon (Number of future intervals related to sampling time).

Control Horizon (Number of control moves to the time steps).

Weight on velocity tracking (Higher weight will reduce the tracking error).

Weight on lateral error (Higher weight will reduce the lateral error).

Weight on change of longitudinal accel (Higher weight will produce less-aggressive vehicle acceleration).

Weight on change of steering angle (Higher weight will produce less-aggressive steering angle change).

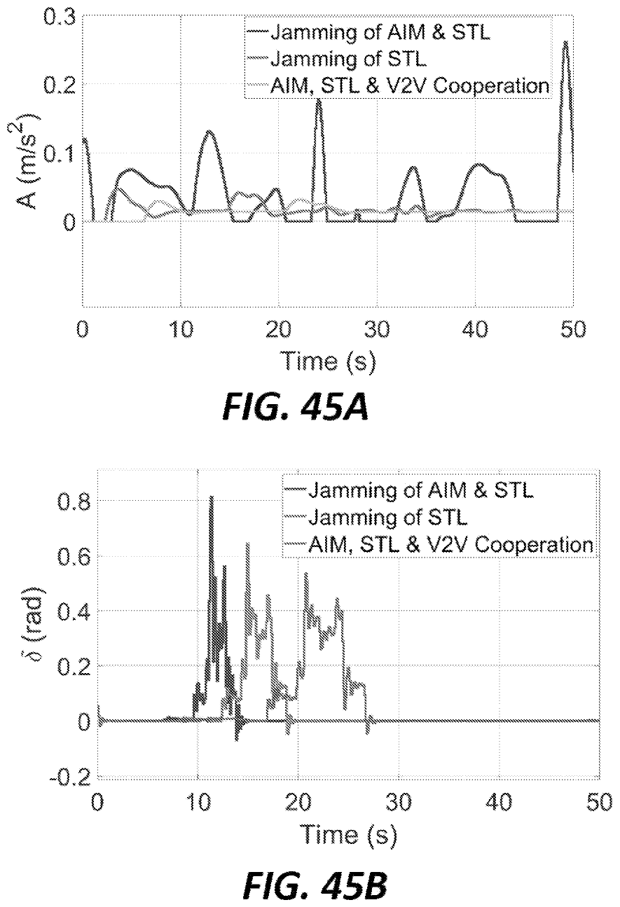

Three intersection threat scenarios are simulated including jamming of AIM and STL; Jamming of STL and Cooperation of all infrastructure devices. The capacity results of the scenarios are illustrated in FIG. 45A and FIG. 45B, where FIG. 45A illustrates acceleration as a function of time for each scenario and FIG. 45B illustrates steering angles as a function of time for each scenario.

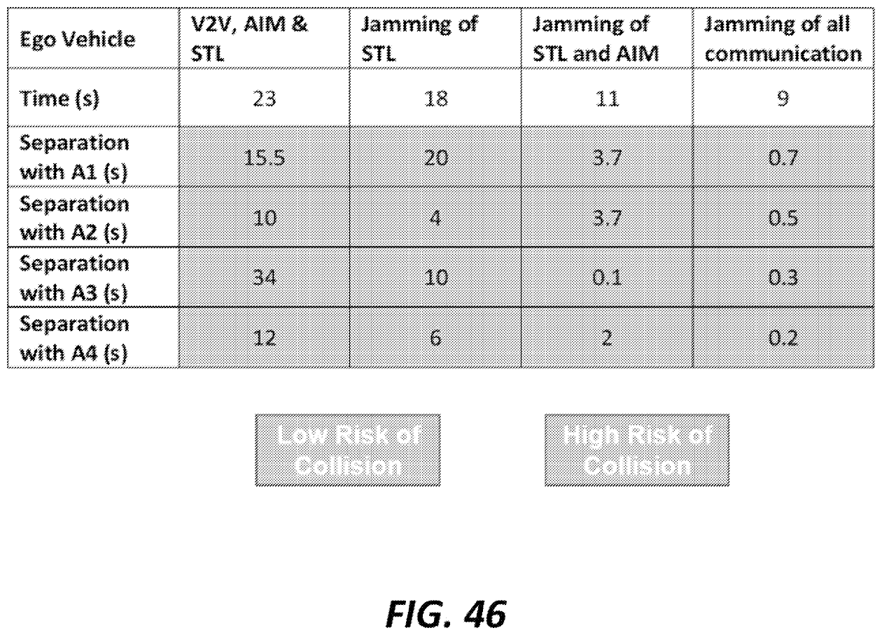

A table shown in FIG. 46 illustrates the risks of collision evaluated by the study for different scenarios.

The present disclosure can overcome limitations of using GNSS (e.g., GPS), Radar, Lidar, and camera sensors by using cooperative methods to incorporate data from multiple vehicles and control multiple vehicles. GPS can include absolute velocity, position, and time. But radar systems, LIDAR systems, and cameras can be limited to providing only relative positions of objects at relative times.

As used herein, the term “smart intersection” can refer to systems including any or all of the following features: an Autonomous Intersection Management system, a smart traffic light, and/or a RoadSide Unit. An Autonomous Intersection Management system can optionally include a system to reserve times of arrival at the intersection. The smart traffic light can optionally implement SPAT (Signal phase and timing) and MAP (an intersection map).

The RoadSide Unit can optionally include both infrastructure parameters and/or V2v and/or V2X communication.

As used herein, the term “connected autonomous vehicles” can refer to vehicles including a cooperative navigation system. The cooperative navigation system can include a cooperative collision avoidance system to maintain separation between vehicles and/or vehicles and pedestrians. The cooperative navigation system can further include a cooperative MPC-based lane-keeping assist system to perform lane centering. The Cooperative Navigation system can further include a cooperative MPC Adaptive Cruise Control System configured to maintain a safe distance from a lead vehicle. It should be understood that connected autonomous vehicles can include any or all of these features, and can include features in addition to these features.

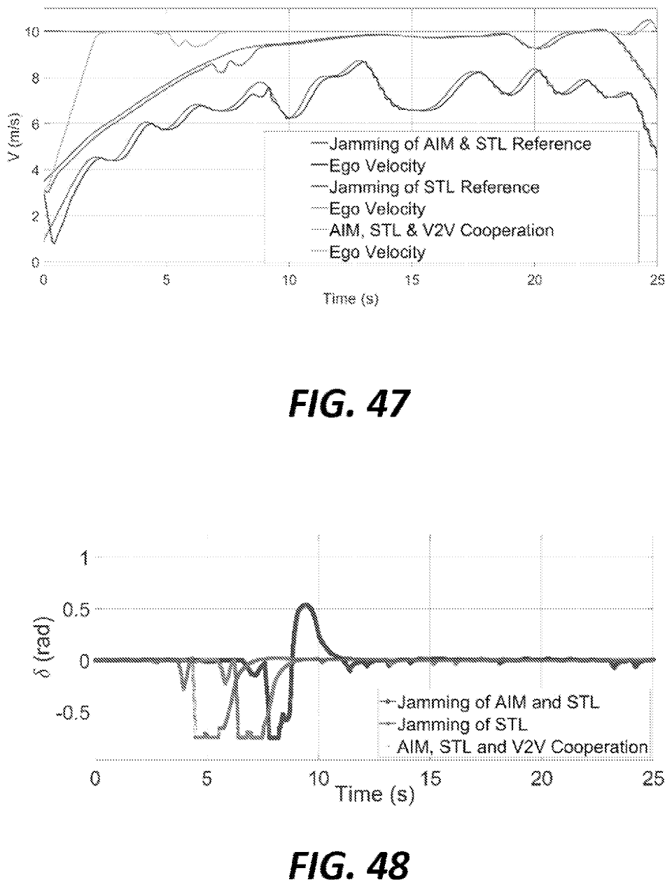

Referring to FIGS. 47-50, additional experiments and analyses were performed on example implementations of the present disclosure including static and dynamic scenarios. As used herein, a static scenario is a scenario where the conflict point is static, and a dynamic scenario is a scenario where the conflict point is not static. In the static scenario, increases in cooperation increase velocity. Ego vehicles approach the intersection earlier as cooperation increases in the static scenario.

In the dynamic scenario, velocity decreases when cooperation increases. The ego vehicle approaches the intersection later as cooperation increases. It should be understood that the results illustrated in FIGS. 47-50 are non-limiting examples that correspond to a single experimental implementation.

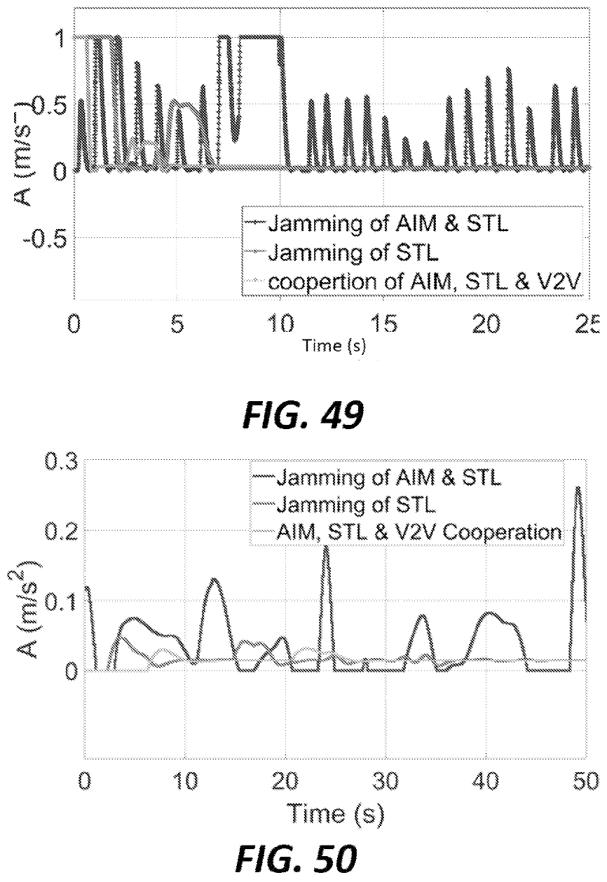

FIG. 47 illustrates velocity as a function of time for different scenarios, according to an implementation of the preset disclosure. FIG. 48 illustrates steering angle as a function of time for different scenarios, according to an implementation of the present disclosure. FIG. 49 illustrates acceleration as a function of time according to an example implementation of the present disclosure. FIG. 50 illustrates acceleration as a function of time according to an example implementation of the present disclosure.

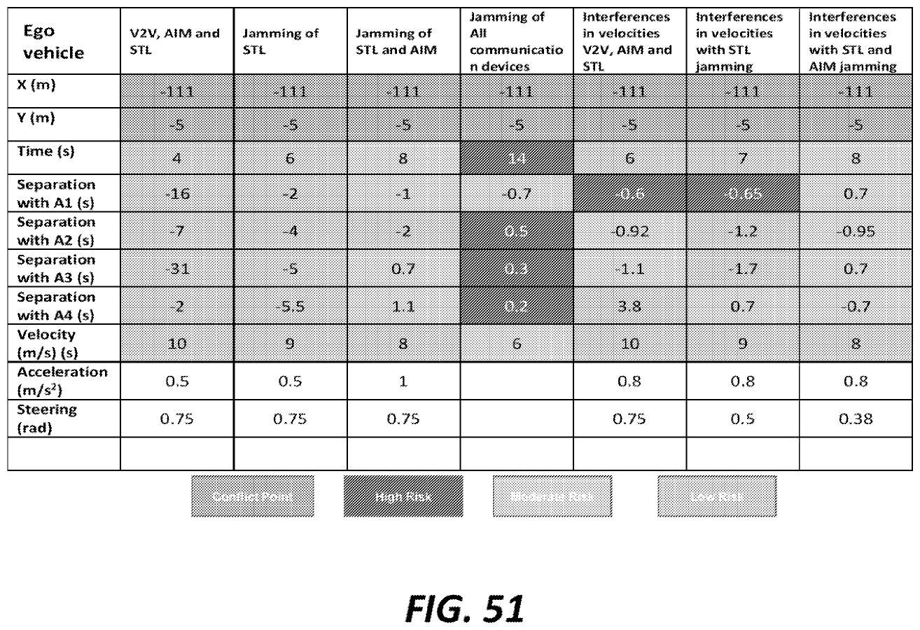

FIG. 51 illustrates a table showing simulation results for different jamming scenarios. As shown in FIG. 51, different jamming scenarios can result in different vehicle separations. Closer separations can result in higher risks of collision.

The example implementation includes a cooperative navigation algorithm including lane keeping assist systema and adaptive cruise control systems. The models of predictive control described herein can enhance safety in real-time dynamic scenarios. As described herein, the cooperative navigation methods can include methods of simulating communication jamming. Finally, implementations of the present disclosure can include machine learning frameworks to simulate and/or implement cooperative navigation systems and methods.

### REFERENCES

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.
Arizala, A., Lattarulo, R., Zubizarreta, A., and Pérez, J. (2021). A control testing framework for automated driving functionalities using modular architecture with ros/carla environment. In 2021 25th International Conference on System Theory, Control and Computing (ICSTCC), 314-320. doi: 10.1109/ICSTCC52150.2021.9607221.
Barzilai, O., Voloch, N., Hasgall, A., Steiner, O. L., and Ahituv, N. (2018). Traffic control in a smart intersection by an algorithm with social priorities. Contemporary Engineering Sciences, 11(31), 1499-1511.
Bian, M., Chen, L., Luo, Y., and Li, K. (2014). A dynamic model for tire/road friction estimation under combined longitudinal/lateral slip situation. Technical report, SAE Technical Paper.
Bifulco, G. N., Coppola, A., Loizou, S. G., Petrillo, A., and Santini, S. (2021). Combined energy-oriented path following and collision avoidance approach for autonomous electric vehicles via nonlinear model predictive control. In 2021 IEEE International Conference on Environment and Electrical Engineering and 2021 IEEE Industrial and Commercial Power Systems Europe (EEEIC/I CPS Europe), 1-6. doi: 10.1109/EEEIC/ICPSEurope51590.2021.9584501.
Cocks, M. and Johnson, N. (2021). Smart city technologies in the usa: Smart grid and transportation initiatives in columbus, ohio. In Smart Cities for Technological and Social Innovation, 217-245. Elsevier.
Code, T.G.S.T. (1995). Sae international surface vehicle recommended practice.
Huang, Z., Liu, L., Wang, D., Wang, H., and Peng, Z. (2021). Collision-free cooperative kinematic guidance laws for multiple unmanned surface vehicles subject to static and dynamic obstacles. In 2021 11th International Conference on Information Science and Technology (ICIST), 565-570. doi: 10.1109/ICIST52614.2021.9440643.
Khayatian, M., Mehrabian, M., Andert, E., Dedinsky, R., Choudhary, S., Lou, Y., and Shirvastava, A. (2020). A survey on intersection management of connected autonomous vehicles. ACM Transactions on CyberPhysical Systems, 4(4), 1-27.
Kim, H. and Ryu, J. (2011). Sideslip angle estimation considering short-duration longitudinal velocity variation. International Journal of Automotive Technology, 12(4), 545-553.
Martinsen, A. B. (2021). Optimization-based planning and control for autonomous surface vehicles.
Milo, C. (2020). Intersection Simulation and Path Estimation. Ph.D. thesis.
Pourmehrab, M., Elefteriadou, L., and Ranka, S. (2017). Smart intersection control algorithms for automated vehicles. In 2017 Tenth International Conference on Contemporary Computing (IC3), 1-6. doi: 10.1109/IC3.2017.8284361.
Wang, H., Meng, Q., Chen, S., and Zhang, X. (2021). Competitive and cooperative behaviour analysis of connected and autonomous vehicles across unsignalised intersections: A game-theoretic approach. Transportation research part B: methodological, 149, 322-346.
Xu, C. Z., Han, Z. H., Zhang, K. S., and Song, W. (2018). Surrogate-based optimization method applied to multidisciplinary design optimization architectures. In 31st congress of the International Council Of The Aeronautical Sciences (ICAS 2018).
Al-Stouhi, S. K. (2019). System and method for providing vehicle collision avoidance at an intersection. U.S. Pat. No. 10,220,845.
Villari, A. B. (2020). A multi-agent autonomous intersection management (MA-AIM) system for smart cities leveraging edge-of-things and Blockchain}, Information Sciences, 148-163.
Rakha, Y. B. (2019). Real-time optimal intersection control system for automated/cooperative vehicles. International Journal of Transportation Science and Technology, 1-12.
Chen, Y. a. (2019). An Autonomous T-Intersection Driving Strategy Considering Oncoming Vehicles Based on Connected Vehicle Technology. IEEE/ASME Transactions on Mechatronics, 2779-2790.
Milo, C. (2020). Intersection Simulation and Path Estimation.
Niels, T. a. (2019). Smart Intersection Management for Connected and Automated Vehicles and Pedestrians. 2019 6th International Conference on Models and Technologies for Intelligent Transportation Systems (MT-ITS), 1-10.
Shen, Z. a. (2019). Coordination of connected autonomous and human-operated vehicles at the intersection. 2019 IEEE/ASME International Conference on Advanced Intelligent Mechatronics (AIM), 1391-1396.
Vaio, M. D. (2019). Design and Experimental Validation of a Distributed Interaction Protocol for Connected Autonomous Vehicles at a Road Intersection. IEEE Transactions on Vehicular Technology, 9451-9465.
Xihui, W. a. (2020). Predictive Motion Planning of Vehicles at Intersection Using a New GPR and RRT. 2020 IEEE 23rd International Conference on Intelligent Transportation Systems (ITSC), 1-6.
Arizala, A. a. (2021). A Control Testing Framework for automated driving functionalities using modular architecture with ROS/CARLA environment. 2021 25th International Conference on System Theory, Control and Computing (ICSTCC, 314-320.
Park, C.-H. a.-C. (2019). Implementation of Autonomous Driving Vehicle at an Intersection with Traffic Light Recognition and Vehicle Controls. VEHITS, 542-549.
Bifulco, G. N. (2021). Combined Energy-oriented Path Following and Collision Avoidance approach for Autonomous Electric Vehicles via Nonlinear Model Predictive Control. 2021 IEEE International Conference on Environment and Electrical Engineering and 2021 IEEE Industrial and Commercial Power Systems Europe (EEEIC/1 CPS Europe), 1-6.
Huang, Z. a. (2021). Collision-free Cooperative Kinematic Guidance Laws for Multiple Unmanned Surface Vehicles Subject to Static and Dynamic Obstacles. 2021 11th International Conference on Information Science and Technology (ICIST, 565-570.
Kim, M. a. (2021). Model Predictive Control Method for Autonomous Vehicles Using Time-Varying and Non-Uniformly Spaced Horizon. IEEE Access, 86475-86487.
Lin, Q. a. (2021). Safe and Resilient Practical Waypoint-Following for Autonomous Vehicles. IEEE Control Systems Letters, 1574-1579.
Martinsen, A. B. (2021). Optimization-based Planning and Control for Autonomous Surface Vehicles. NTNU.
Ramanata, P. P. (1998). Optimal vehicle path generator using optimization methods. Virginia Tech.
Song, W. a. (2016). Intention-aware autonomous driving decision-making in an uncontrolled intersection. Mathematical Problems in Engineering.
Tian, R. a. (2020). Game-Theoretic Modeling of Traffic in Unsignalized Intersection Network for Autonomous Vehicle Control Verification and Validation. IEEE Transactions on Intelligent Transportation Systems, 1-16.
Wang, M. a. (2021). Game-Theoretic Planning for Self-Driving Cars in Multivehicle Competitive Scenarios. IEEE Transactions on Robotics, 1313-1325.
Wang, Y. a. (2021). Path Following by Formations of Agents with Collision Avoidance Guarantees using Distributed Model Predictive Control. 2021 American Control Conference (ACC, 3352-3357.
Yu, T. a. (2021). Design and Implementation of a Small-scale Autonomous Vehicle for Autonomous Parking. 2021 6th International Conference on Automation, Control and Robotics Engineering (CACRE), 398-402.
Zhu, D.-D. a.-Q. (2021). A New Algorithm Based on Dijkstra for Vehicle Path Planning Considering Intersection Attribute. IEEE Access, 19761-19775.
[1B] M. Khayatian, M. Mehrabian, E. Andert, R. Dedinsky, S. Choudhary, Y. Lou, and A. Shirvastava, “A survey on intersection management of connected autonomous vehicles,” ACM Transactions on Cyber-Physical Systems, vol. 4, no. 4, pp. 1-27, 2020.
[2B]M. Cocks and N. Johnson, “Smart city technologies in the usa: Smart grid and transportation initiatives in columbus, ohio,” in Smart Cities for Technological and Social Innovation, pp. 217-245, Elsevier, 2021.
[3B]S. Jing, F. Hui, X. Zhao, J. Rios-Torres, and A. J. Khattak, “Integrated longitudinal and lateral hierarchical control of cooperative merging of connected and automated vehicles at on-ramps,” IEEE Transactions on Intelligent Transportation Systems, vol. 23, no. 12, pp. 24248-24262 2022.
[4B]H. Wang, Q. Meng, S. Chen, and X. Zhang, “Competitive and cooperative behaviour analysis of connected and autonomous vehicles across unsignalised intersections: A game-theoretic approach,” Transportation research part B: methodological, vol. 149, pp. 322-346, 2021.
[5B]S. K. S. Nakka, B. Chalaki, and A. A. Malikopoulos, “A multi-agent deep reinforcement learning coordination framework for connected and automated vehicles at merging roadways,” in 2022 American Control Conference (ACC), pp. 3297-3302, IEEE, 2022.
[6B]Z. Zhu, L. Adouane, and A. Quilliot, “Intelligent traffic based on hybrid control policy of connected autonomous vehicles in multiple unsignalized intersections,” in 2021 IEEE SmartWorld, Ubiquitous Intelligence & Computing, Advanced & Trusted Computing, Scalable Computing & Communications, Internet of People and Smart City Innovation (SmartWorld/SCALCOM/UIC/ATC/IOP/SCI), pp. 416-424, IEEE, 2021.
[7B]N. Kamath B, R. Fernandes, A. P. Rodrigues, M. Mahmud, P. Vijaya, T. R. Gadekallu, and M. S. Kaiser, “Taken: A traffic knowledge-based navigation system for connected and autonomous vehicles,” Sensors, vol. 23, no. 2, p. 653, 2023.
[8B]L. Chen and C. Englund, “Cooperative intersection management: A survey,” IEEE transactions on intelligent transportation systems, vol. 17, no. 2, pp. 570-586, 2015.
[9B]A. Gholamhosseinian and J. Seitz, “A comprehensive survey on cooperative intersection management for heterogeneous connected vehicles,” IEEE Access, vol. 10, pp. 7937-7972, 2022.
[10B]A. M. M. Sizkouhi, M. Rahimifard, and R. R. Selmic, “Covert attack and detection through deep neural network on vision-based navigation systems of multi-agent autonomous vehicles,” in 2022 IEEE International Conference on Systems, Man, and Cybernetics (SMC), pp. 2583-2590, IEEE, 2022
[11B]A. Mirheli, M. Tajalli, L. Hajibabai, and A. Hajbabaie, “A consensus based distributed trajectory control in a signal-free intersection,” Transportation research part C emerging technologies, vol. 100, pp. 161-176, 2019.
[12B]X. Sun, F. R. Yu, and P. Zhang, “A survey on cyber-security of connected and autonomous vehicles (cavs),” IEEE Transactions on Intelligent Transportation Systems, vol. 23, no. 7, pp. 6240-6259, 2021.
[13B]R. Valiente, M. Razzaghpour, B. Toghi, G. Shah, and Y. P. Fallah, “Prediction-aware and reinforcement learning based altruistic cooperative driving,” arXiv preprint arXiv:2211.10585, 2022
[14B]R. Khan, A. Hanif, and Q. Ahmed, “Cooperative navigation strategy for connected autonomous vehicle operating at smart intersection,” in 2022 10th IFAC Conference on AAC, no. 0051, 2022.
[15B]Z. Huang, L. Liu, D. Wang, H. Wang, and Z. Peng, “Collision-free cooperative kinematic guidance laws for multiple unmanned surface vehicles subject to static and dynamic obstacles,’ in 2021 11th International Conference on Information Science and Technology (ICIST), pp. 565570, 2021.
[16B]G. N. Bifulco, A. Coppola, S. G. Loizou, A. Petrillo, and S. Santini, “Combined energy-oriented path following and collision avoidance approach for autonomous electric vehicles via nonlinear model predictive control.,” in 2021 IEEE International Conference on Environment and Electrical Engineering and 2021 IEEE Industrial and Commercial Power Systems Europe (EEEIC/I CPS Europe), pp. 1-6, 2021.
[17B]H. Wang, Q. Meng, S. Chen, and X. Zhang, “Competitive and cooperative behavior analysis of connected and autonomous vehicles across unsignalized intersections: A game-theoretic approach,” Transportation research part B: methodological, vol. 149, pp. 322-346, 2021.
[18B]C.-Z. Xu, Z.-H. Han, K.-S. Zhang, and W. Song, “Surrogate-based optimization method applied to multidisciplinary design optimization architectures,” in 31st congress of the International Council Of The Aeronautical Sciences (ICAS 2018), 2018.

What is claimed:

1. A system for performing cooperative navigation with autonomous vehicles, the system comprising:
an autonomous vehicle;
a communication system; and
a vehicle control system, the vehicle control system comprising a processor and a memory, the memory having computer-executable instructions stored thereon that, when executed by the processor, cause the processor to:
receive traffic information from the communication system, wherein the traffic information comprises first information from a plurality of roadside communication devices and second information from a second vehicle;
receive a plurality of vehicle parameters associated with the autonomous vehicle;
determine, based on the traffic information and the vehicle parameters, a cooperative navigation solution.

2. The system of claim 1, further comprising controlling the autonomous vehicle using the cooperative navigation solution.

3. The system of claim 1 or claim 2, wherein the vehicle control system is attached to the autonomous vehicle.

4. The system of any one of claims 1-3, wherein the cooperative navigation solution comprises a vehicle velocity instruction, wherein the vehicle velocity instruction comprises a velocity that avoids a potential collision.

5. The system of any one of claims 1-4, wherein the cooperative navigation solution comprises a cooperative cruise control instruction.

6. The system of any one of claims 1-5, wherein the cooperative navigation solution comprises cooperative adaptive lane keeping information.

7. The system of any one of claims 1-6, wherein the cooperative navigation solution comprises cooperative collision avoidance information.

8. The system of any one of claims 1-7, wherein the roadside communication devices comprise a road side unit (RSU).

9. The system of any one of claims 1-8, wherein the roadside communication devices comprise a smart traffic light (STL).

10. The system of any one of claims 1-9, wherein the roadside communication devices comprise a smart traffic sign (STS).

11. The system of any one of claims 1-10, wherein the roadside communication devices comprise an automated traffic management (ATM) system.

12. The system of any one of claims 1-11, wherein the vehicle parameters comprise a vehicle length.

13. The system of any one of claims 1-12, wherein the vehicle parameters comprise a vehicle position.

14. The system of any one of claims 1-13, wherein the vehicle parameters comprise a heading angle.

15. The system of any one of claims 1-14, wherein the vehicle parameters comprise a lane identity of the vehicle.

16. The system of any one of claims 1-15, wherein the vehicle parameters comprise a turn identification of the vehicle.

17. The system of any one of claims 1-16, wherein the communication system comprises an autonomous intersection management system.

18. The system of any one of claims 1-17, further comprising a light detection and ranging (LIDAR) sensor, and wherein the plurality of vehicle parameters comprise LIDAR data.

19. The system of any one of claims 1-18, further comprising a radar sensor, and wherein the plurality of vehicle parameters comprise radar data.

20. The system of any one of claims 1-19, further comprising a camera, and wherein the plurality of vehicle parameters comprise image data.

21. A computer-implemented method of performing cooperative collision avoidance for an autonomous vehicle, the method comprising:
receiving traffic information from a communication system, wherein the traffic information comprises first information from a plurality of roadside communication devices and second information from a second vehicle;
receiving a plurality of vehicle parameters associated with the autonomous vehicle;
determining, based on the traffic information and the vehicle parameters, a cooperative navigation solution.

22. The computer-implemented method of claim 21, wherein the cooperative navigation solution comprises a vehicle velocity, wherein the vehicle velocity is a velocity that avoids a potential collision.

23. The computer-implemented method of claim 21 or claim 22, wherein the cooperative navigation solution comprises cooperative cruise control information.

24. The computer-implemented method of any one of claims 21-23, wherein the cooperative navigation solution comprises cooperative adaptive lane keeping information.

25. The computer-implemented method of any one of claims 21-24, wherein the cooperative navigation solution comprises cooperative collision avoidance information.

26. The computer-implemented method of any one of claims 21-25, wherein the roadside communication devices comprise a road side unit (RSU).

27. The computer-implemented method of any one of claims 21-26, wherein the roadside communication devices comprise a smart traffic light (STL).

28. The computer-implemented method of any one of claims 21-27, wherein the roadside communication devices comprise a smart traffic sign (STS).

29. The computer-implemented method of any one of claims 21-28, wherein the roadside communication devices comprise an automated traffic management (ATM) system.

30. The computer-implemented method of any one of claims 21-29, wherein the vehicle parameters comprise a vehicle length.

31. The computer-implemented method of any one of claims 21-30, wherein the vehicle parameters comprise a vehicle position.

32. The computer-implemented method of any one of claims 21-31, wherein the vehicle parameters comprise a heading angle.

33. The computer-implemented method of any one of claims 21-32, wherein the vehicle parameters comprise a lane identity of the vehicle.

34. The computer-implemented method of any one of claims 21-33, wherein the vehicle parameters comprise a turn identification of the vehicle.

35. The computer-implemented method of any one of claims 21-34, wherein the communication system comprises an autonomous intersection management system.

36. The computer-implemented method of any one of claims 21-35, wherein the plurality of vehicle parameters comprise LIDAR data.

37. The computer-implemented method of any one of claims 21-36, wherein the plurality of vehicle parameters comprise RADAR data.

38. The computer-implemented method of any one of claims 21-37, wherein the plurality of vehicle parameters comprise camera data.

39. The computer-implemented method of any one of claims 21-38, further comprising controlling the autonomous vehicle using the cooperative navigation solution.
